(19) United States
(12) Patent Application Publication
(10) Pub. No.: US 2010/0011369 A1
(43) Pub. Date: Jan. 14, 2010

(54) DEVICE MANAGEMENT APPARATUS, JOB FLOW PROCESSING METHOD, AND TASK COOPERATIVE PROCESSING SYSTEM

(75) Inventor: Momoe Uchida, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/442,659

(22) PCT Filed: Jul. 4, 2008
(86) PCT No.: PCT/JP08/62536

§ 371 Date: Mar. 24, 2009

(30) Foreign Application Priority Data
Jul. 18, 2007 (JP) 2007-187602

(51) Int. Cl. G06F 9/50

(52) U.S. Cl. 718/104

(57) ABSTRACT

In a task cooperative processing system that allows a plurality of task processing devices to execute a plurality of tasks performed on document data as a job flow, task processing devices that can execute a task included in the job flow are decided as candidate task processing devices (S82). A task processing device that can execute the largest number of tasks is decided as a primary task processing device from among the candidate task processing devices (S83). If there is a task that DETERMINE CANDIDATE TASK S82 can be executed by the primary task PROCESSING DEVICE processing device if the primary task processing device obtains a license of the task, the primary task processing device obtains the license from another device, and executes the task (S84).

### TECHNICAL FIELD

The present invention relates to a device management apparatus for executing a job flow, a job flow processing method, and a task cooperative processing system.

### BACKGROUND ART

A technique has heretofore been proposed in which a job flow is created by combining processes (tasks) that are to be performed on document data, such as faxing, scanning and printing, in series or in parallel, and a set of processes are executed through the execution of the created job flow. To execute job flows, a service processing apparatus has been proposed that enables a plurality of devices connected to a network to execute a plurality of tasks in cooperation (see, for example, Japanese Patent Laid-Open No. 2004-287859). According to Japanese Patent Laid-Open No. 2004-287859, task processing devices that can process each task of a job flow work in cooperation to sequentially process the tasks with a corresponding task processing device, whereby a plurality of tasks can be executed as a single job flow without imposing a burden on the user.

Meanwhile, Japanese Patent Laid-Open No. 2005-055957 discloses a license management system in which a license is issued from a license management server to a terminal device when necessary, and the license after use is automatically returned to the license management server.

According to Japanese Patent Laid-Open No. 2004-287859, a task included in a job flow is processed by a device that can process the task. Accordingly, this technique requires a plurality of devices to execute a single job flow, depending on the configuration, which results in the problem of inefficient execution of the job flow when data transfer time and the like are considered. Further, Japanese Patent Laid-Open No. 2004-287859 does not specifically consider a license that is necessary to process a task, and therefore if the license scheme is changed irrespective of the job flow, the job flow may not be executed successfully.

### DISCLOSURE OF INVENTION

The present invention has been conceived in light of the related art described above, and it is an object of the present invention to provide a device management apparatus, a job flow processing method, and a task cooperative processing system with a license incorporated, in which the number of task processing devices that execute each task of a job flow is reduced.

The present invention is configured as follows to achieve the above object. Specifically, the present invention provides a device management apparatus that manages task processing devices that process document data by executing a job flow in which a plurality of tasks are combined in units of task, the apparatus including: a determining unit adapted to determine a primary task processing device from among the task processing devices under management; a determining unit adapted to determine a task that requires obtainment of a license when executed by the primary task processing device from a job flow to be executed; a license manager adapted to transfer a license of the task that is determined to require obtainment of a license when executing the task by the determining unit from another task processing device having the license to the primary task processing device; and a scheduler adapted to schedule a task executable by the primary task processing device among the tasks included in the job flow such that the task is executed by the primary task processing device.

According to the present invention, the number of task processing devices that are involved in the execution of a job flow can be reduced, so that the job flow can be executed efficiently.

Further, even if each task license assigned to a task processing device is changed, the job flow can be executed without changing the definition of the job flow.

Further features of the present invention will become apparent from the following description of exemplary embodiments with reference to the attached drawings.

### BRIEF DESCRIPTION OF DRAWINGS

FIG. 1 is a diagram illustrating the system configuration of a service cooperative processing system according to the present invention.

FIG. 2 is a diagram illustrating the overall operation flow according to the present invention.

FIG. 3 is a diagram illustrating task definition information according to the present invention.

FIG. 4A is a diagram showing an exemplary job flow that is used to illustrate job flow definition information according to the present invention.

FIG. 4B is a diagram illustrating exemplary job flow definition information written based on FIG. 4A of the present invention.

FIG. 5 is a diagram illustrating an exemplary job flow according to Embodiment 1 of the present invention.

FIG. 6 is a diagram illustrating a list of task processing devices, the license status thereof, and the status of installed applications according to Embodiment 1 of the present invention.

FIG. 7 is a diagram illustrating a list of candidate task processing devices that can execute a task according to Embodiment 1 of the present invention.

FIG. 8 is a diagram illustrating the overall flow of a process according to Embodiment 1 of the present invention.

FIG. 9 is a flowchart of a process for determining a candidate task processing device for executing a task according to Embodiment 1 of the present invention.

FIG. 10 is a flowchart of a process for deciding a task processing device that executes a task according to Embodiment 1 of the present invention.

FIG. 11 is a flowchart of a license assignment determination process according to Embodiment 1 of the present invention.

FIG. 12 is a flowchart of a license assignment process according to Embodiment 1 of the present invention.

FIG. 13 is a flowchart of a process for executing a job flow according to Embodiment 1 of the present invention.

FIG. 14A is a diagram illustrating executive task processing devices when a job flow is executed according to conventional technology in Embodiment 1 of the present invention.

FIG. 14B is a diagram illustrating executive task processing devices when the job flow is executed according to Embodiment 1 of the present invention.

FIG. 15 is a diagram illustrating an overall configuration according to Embodiment 2 of the present invention.

FIG. 16 is a flowchart of a process for determining a task processing device that executes a task according to Embodiment 2 of the present invention.

FIG. 17 is a diagram illustrating a result according to Embodiment 2 of the present invention.

FIG. 18 is a flowchart of a license assignment process according to Embodiment 3 of the present invention.

FIG. 19 is a flowchart of a process for executing a job flow according to Embodiment 3 of the present invention.

FIG. 20 is a flowchart of a license assignment determination process according to Embodiment 4 of the present invention.

FIGS. 21A and 21B are diagrams illustrating a flow of a license assignment process according to Embodiment 4 of the present invention.

FIG. 22 is a diagram illustrating an overall configuration according to Embodiment 5 of the present invention.

FIG. 23 is a diagram illustrating an exemplary job flow according to Embodiment 5 of the present invention.

FIG. 24 is a diagram illustrating exemplary task definition information according to Embodiment 5 of the present invention.

FIG. 25 is a diagram illustrating a list of task processing devices, the license status thereof, and the status of installed applications according to Embodiment 5 of the present invention.

FIG. 26 is a diagram illustrating a list of candidate task processing devices that can execute a task according to Embodiment 5 of the present invention.

FIGS. 27A and 27B are diagrams illustrating a flow of a process for determining a task processing device that executes a task according to Embodiment 5 of the present invention.

FIG. 28 is a flowchart of a license assignment determination process according to Embodiment 6 of the present invention.

FIG. 29 is a block diagram of a device management apparatus and a task processing device.

### BEST MODE FOR CARRYING OUT THE INVENTION

Embodiments to which the present invention is suitably applied will be described. Before describing the embodiments of the present invention, some terminology used herein is described.

(1) “Task” refers to a unit of processing, and includes, in the present embodiment, for example, copying document data, scanning, faxing, saving in the hard disk of a print processing apparatus, emailing, and so on. Other possibilities include reading (scanning) sheets, inputting document data, recognizing characters of a read-out image, converting into a spreadsheet, saving inputted document data (registering in a database), and so on. A task is executed by a task processing device such as a computer, digital multifunctional peripheral or print processing apparatus. There are various tasks according to the functions of the task processing devices. A task may require a task license for executing the task even if a task processing device that has a function to execute the task is used.

(2) “Task license” refers to information that needs to be provided to a task processing device to enable it to execute the task. Not all tasks require a license, and basic function tasks may be executed without a license. License schemes include a scheme in which an apparatus possesses a license, and a scheme called “floating” that limits the number of tasks that can be executed simultaneously by the licensed users. In the latter license scheme, a server that manages the license performs transmission of the license between task processing devices as necessary. In the present embodiment, a license is possessed by an apparatus (or device), but the license can be transferred temporarily between apparatuses (or devices).

(3) “Job flow” refers to a set of plural tasks that are combined so that they are executed in series or in parallel. A job flow is the concept that represents such a set of tasks, and in the present embodiment, data that defines a job flow is also called a “job flow”. A job flow is created in advance, and is saved in a computer, digital multifunctional peripheral, and so on, that function as device management apparatuses. The user selects a job flow to be executed, and provides an instruction to execute the job flow, whereby the job flow can be executed. The job flow can be configured of, for example, the identifier (task name) of a task, and when it is necessary to input data to the task, the identifier of the input source. If the output data of a given task serves as input data for the next task, the identifier of the input source is the identifier of the given task. However, as for a task that does not require input data such as scanning, it is unnecessary to specify the identifier of the input source. The tasks included in a job flow are each executed by a task processing device, and the output data of a task is delivered to another task that processes the output data as an input. In the present embodiment, a task that receives an input of the data output from a current task in accordance with the data transfer order is referred to as “next task”, and the task that outputs the data to be input to a current task is referred to as “previous task”. The previous task and the next task are not necessarily in one-to-one correspondence, and may be in one-to-multiple correspondence or multiple-to-one correspondence.

(4) A device management apparatus is connected to task processing devices via a network to form a task cooperative processing system. The task cooperative processing system manages a job flow and task processing devices, and schedules a task of the job flow so that it is executed by a task processing device that can execute the task. The task cooperative processing system may have a function for organizing task license transmission as well. In the present embodiment, a job flow is performed on document data, but it may be performed on another type of data such as image data. A job flow is not always executed or instructed by the device management apparatus. For example, a created job flow may be saved in a computer or digital multifunctional peripheral, and an execution instruction may be given by the computer or digital multifunctional peripheral. Alternatively, a task processing device may also have a function as a device management apparatus.

The present invention can be summarized as follows. Specifically, the present invention includes a deciding means for (deciding step of) deciding a primary task processing device from among task processing devices that are managed by a device management apparatus. This corresponds to a process of deciding an executive task processing device in an embodiment. The present invention also includes a determining means for (determining step of) determining a task, of a job flow to be executed, that requires a license when executed by the decided primary task processing device. This corresponds to a license assignment determination process in an embodiment. The present invention also includes a license manager for (license managing step of) transferring a license of a task that is determined to require a license when executed from another task processing device that has the license to the primary task processing device. This corresponds to a license assignment process in an embodiment. The present invention also includes a scheduling means for (step of) scheduling a task, among the tasks of the job flow to be executed, that is executable by the primary task processing device such that the task is executed by the primary task processing device. This corresponds to a JF execution process in an embodiment.

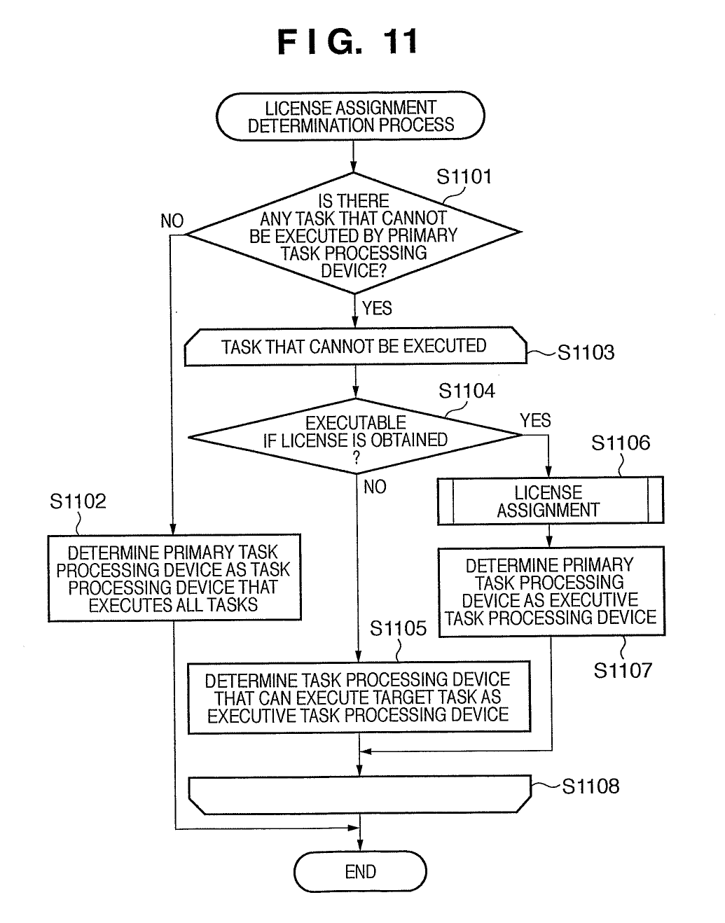

Further, when deciding a primary task processing device, a task processing device that has the largest number of executable tasks in the job flow to be executed is determined as the primary task processing device from among the task processing devices under management of the device management apparatus. This corresponds to step S1005 of FIG. 10, or the like.

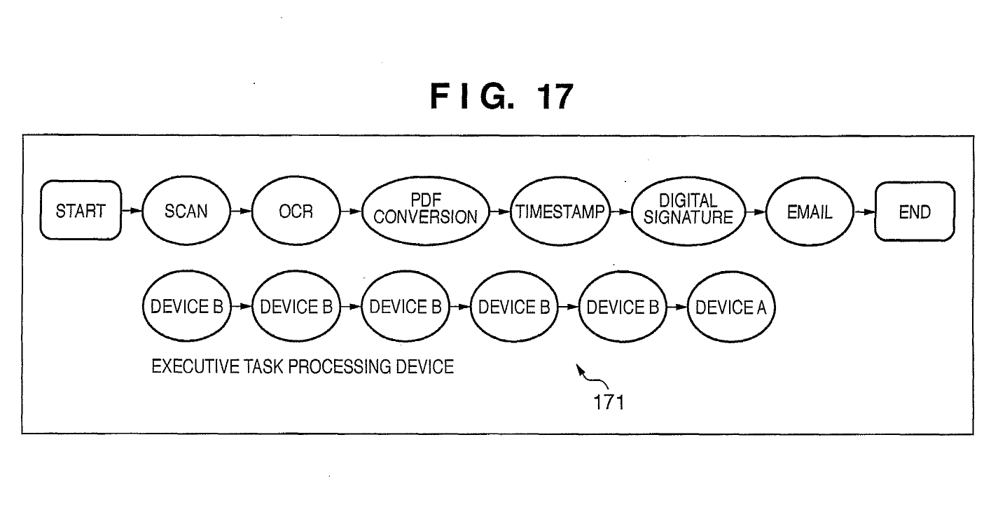

Alternatively, when deciding a primary task processing device, a task processing device to which an instruction to execute the job flow to be processed is provided is determined as the primary task processing device from among the task processing devices under management of the device management apparatus. This corresponds to step S1604 of FIG. 16, or the like.

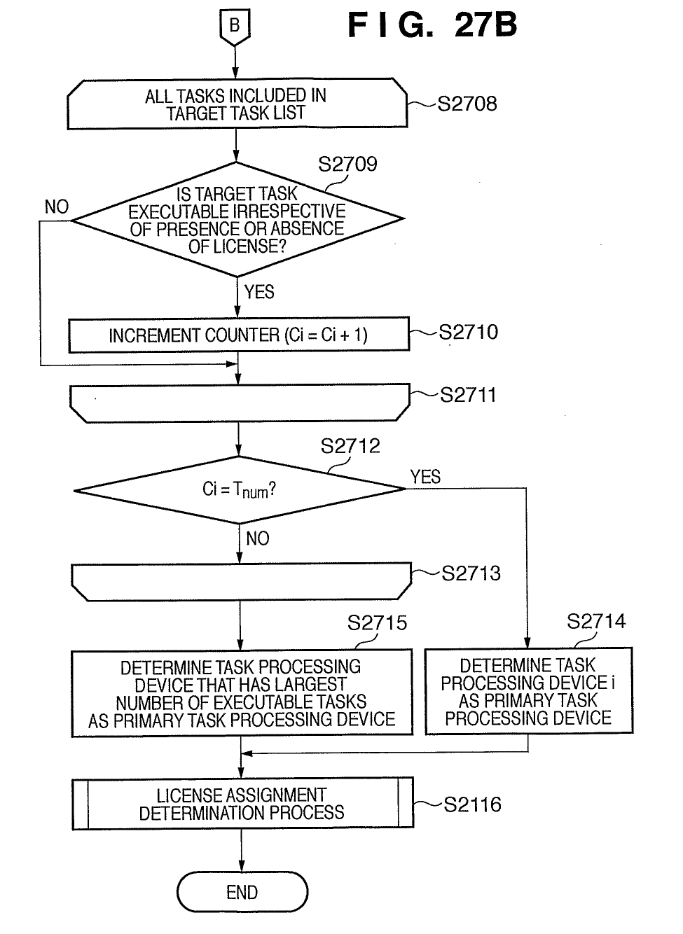

Alternatively, when deciding a primary task processing device, a task processing device that has the largest number of executable tasks in the job flow to be executed that require a user's manual operation is determined as the primary task processing device from among the task processing devices under management of the device management apparatus. This corresponds to S2714 or S2715 of FIG. 27B.

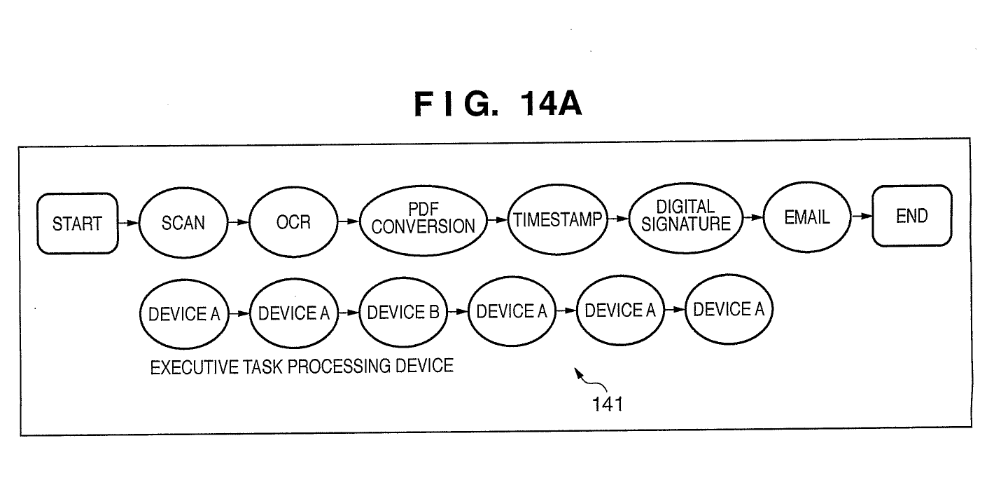

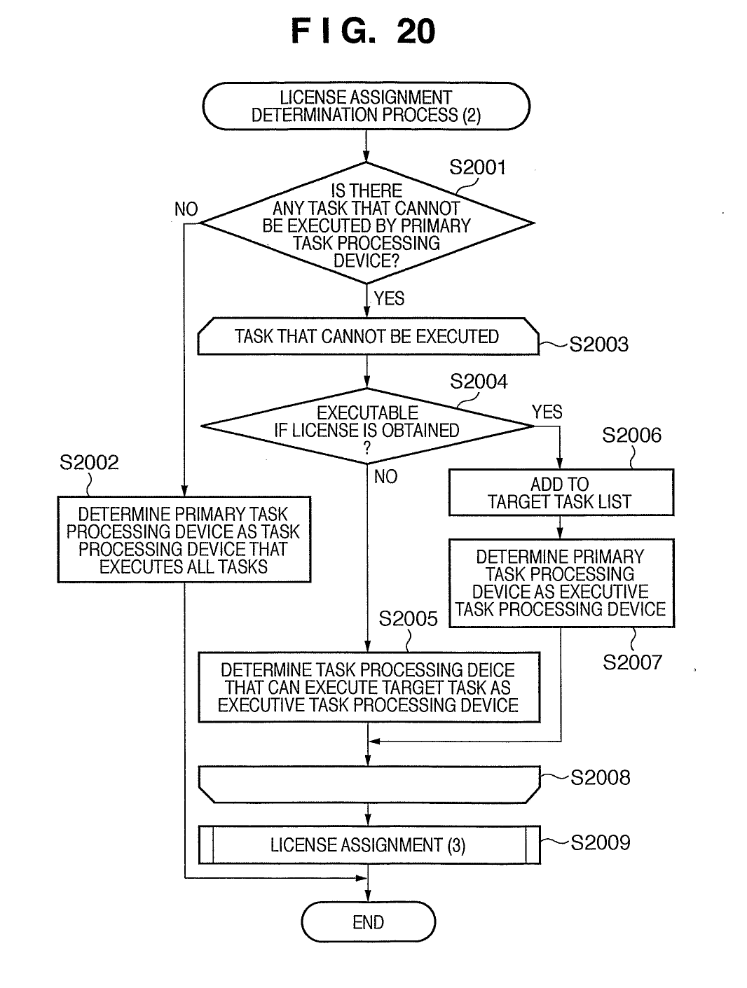

The present invention further includes a means for (step of) returning a license that has been returned from the primary task processing device to the another task processing device from which the license was obtained. This corresponds to S1306 of FIG. 13, S1905 of FIG. 19, or the like.

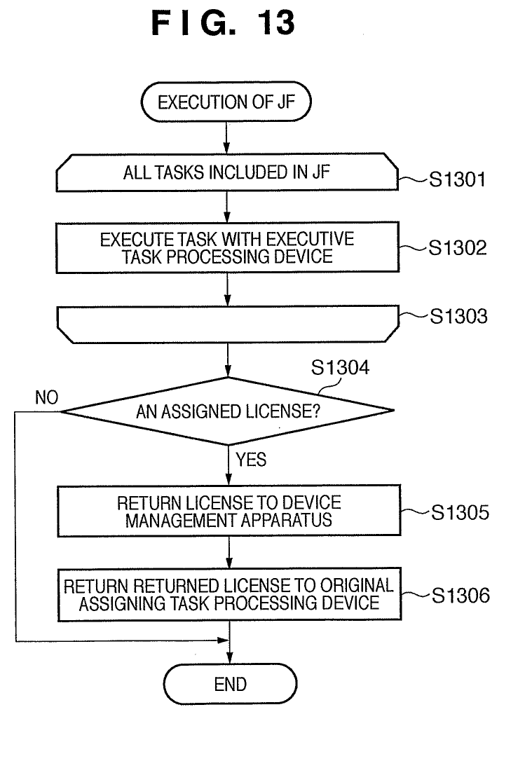

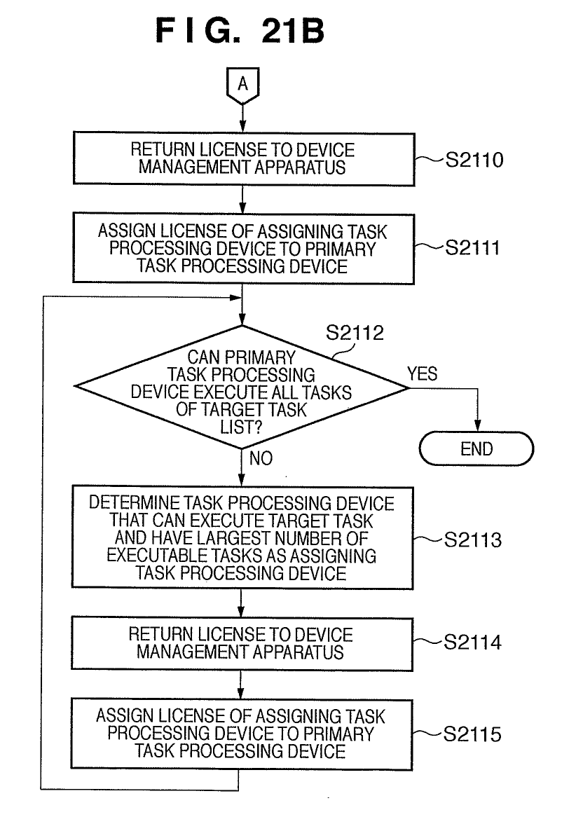

When transferring a license, in response to a request from the primary task processing device, a license is obtained from another task processing device, and the license is assigned to the primary task processing device. This corresponds to FIG. 12, or the process ranging from FIGS. 21A to 21B.

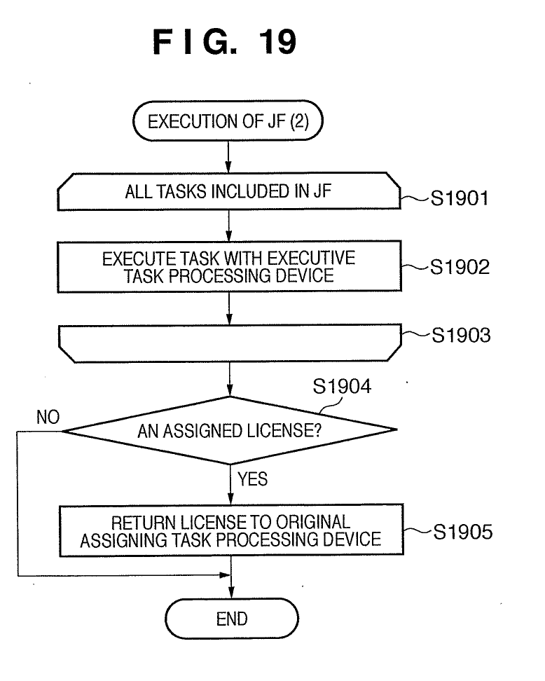

When transferring a license, in response to a request from the primary task processing device, the primary task processing device is notified of another task processing device that has a license of the task required by the primary task processing device. The primary task processing device obtains the license from that task processing device. This corresponds to, for example, the process of FIG. 18.

As described above, the present invention can be summarized based on embodiments. Before describing the embodiments of the present invention, a system configuration and an application configuration to which the present invention can be applied is described first.

### EMBODIMENT 1

### <System Configuration>

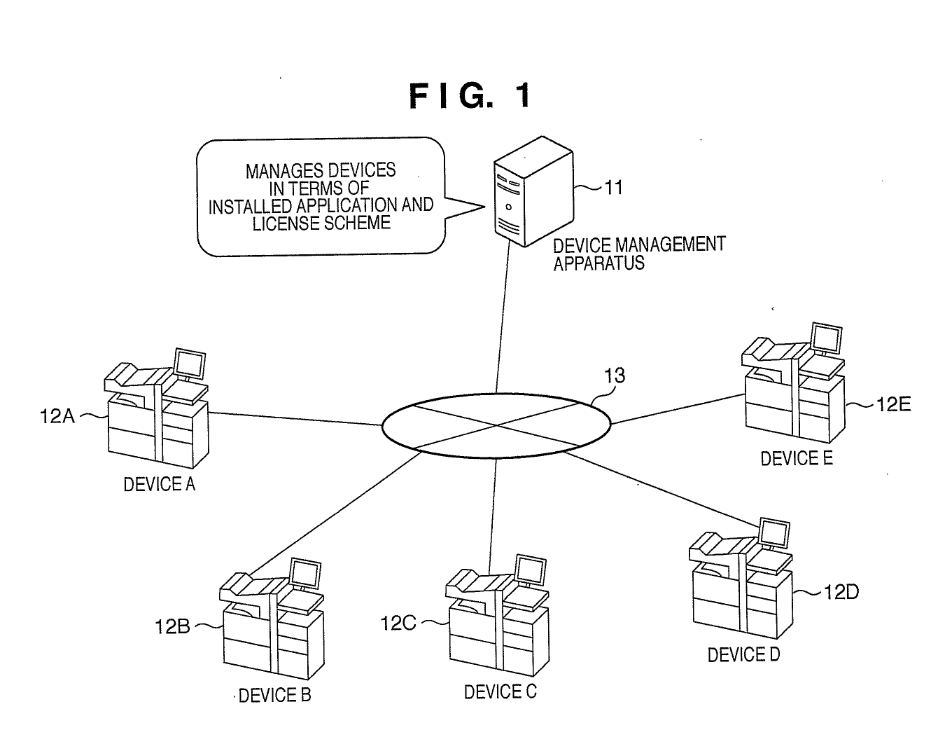

FIG. 1 is a diagram illustrating the overall configuration of a task cooperative processing system according to an embodiment of the present invention. The task cooperative processing system is a system that is configured by connecting a device management apparatus and task processing devices that are described above. This is a cooperative processing system that can execute various tasks including a task of a print processing apparatus. The task cooperative processing system of an embodiment of the present invention can work in cooperation with a plurality of applications that can provide various tasks, in addition to the print processing apparatus that provides a task.

This task cooperative processing system includes a device management apparatus 11, and task processing devices 12A to 12E that are connected via a network 13. Data communication is possible between task processing devices, as well as between a task processing device and the device management apparatus using protocols such as TCP/IP and SNMP. It should be noted that the number of devices is not limited. The descriptions below assume that a task cooperative processing system includes a single device management apparatus and five task processing devices that are connected to the device management apparatus.

The device management apparatus 11 manages task processing devices, such as a print processing apparatus and applications, and a plurality of job flows. It also manages information regarding applications that have been installed in the task processing devices under management and the license scheme. It is assumed that, in order to execute a task, a license that allows a task processing device to execute the task is issued.

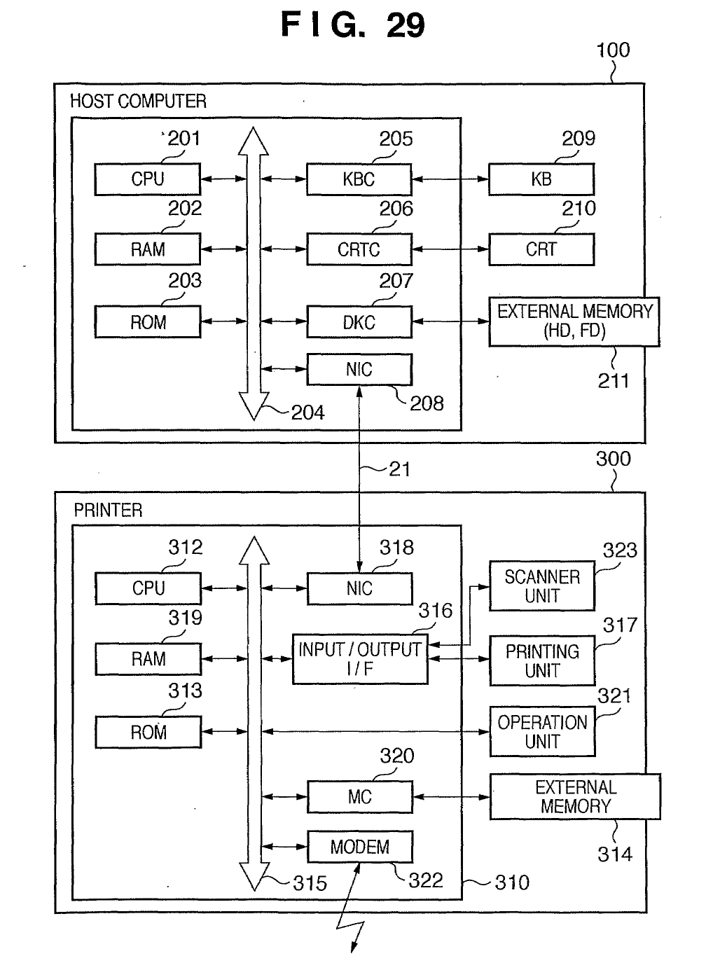

FIG. 29 shows a block diagram of a computer 100 that functions as a task processing device or device management apparatus, and a print processing apparatus (digital multifunctional peripheral) 300 that functions as a device management apparatus.

In FIG. 29, the computer 100 includes a CPU 201 that processes documents that contain graphics, images, characters, tables (including spreadsheets), and so on, based on a document processing program stored in a ROM 203 or an external memory 211. The CPU 201 collectively controls devices that are connected to a system bus 204. A RAM 202 functions as the main memory, working area, and the like of the CPU 201. A keyboard controller (KBC) 205 controls key inputs from a keyboard 209 and a pointing device (not shown). A CRT controller (CRTC) 206 controls the display of a CRT display 210. A disk controller (DKC) 207 controls access to the external memory 211 that stores a boot program and various applications, such as a hard disk (HD). The applications include programs for managing the devices and programs for processing tasks. A printer controller (PRTC) 208 is connected to a network via a network interface card (NIC) 21, and executes control processing for communication with the network 21. The CPU 201 opens various registered windows based on commands inputted through a mouse cursor (not shown) displayed on the CRT 210, or the like, and executes various data processes.

In the printer 300, a printer CPU 312 collectively controls access to various devices connected to a system bus 315 based on a control program stored in a ROM 313 or an external memory 314. The CPU 312 also outputs an image signal as output information to a printing unit (printer engine) 317 that is connected thereto via an input/output I/F 316. Digital image data is inputted from a scanner unit 323. The CPU 312 is connected to a network via the NIC 21, and executes control processing for communication with the network 21. The RAM 319 is a RAM that functions as the main memory, working area, and the like of the CPU 312. A NIC 318 receives input data that needs to be processed through the execution of a task from the computer 100 or another task processing device via the network 21, and transmits the processed data. A memory controller (MC) 320 controls access to the external memory 314 that stores programs and data, such as a hard disk (HD). An operation unit 321 includes a display panel and a keyboard, with which information is provided to the operator, or instructions are input by the operator. Instructions to select/execute a job flow can be input through the operation unit 321. A modem 322 that is connected to a public network is provided to enable facsimile communication.

<Operation Flow>

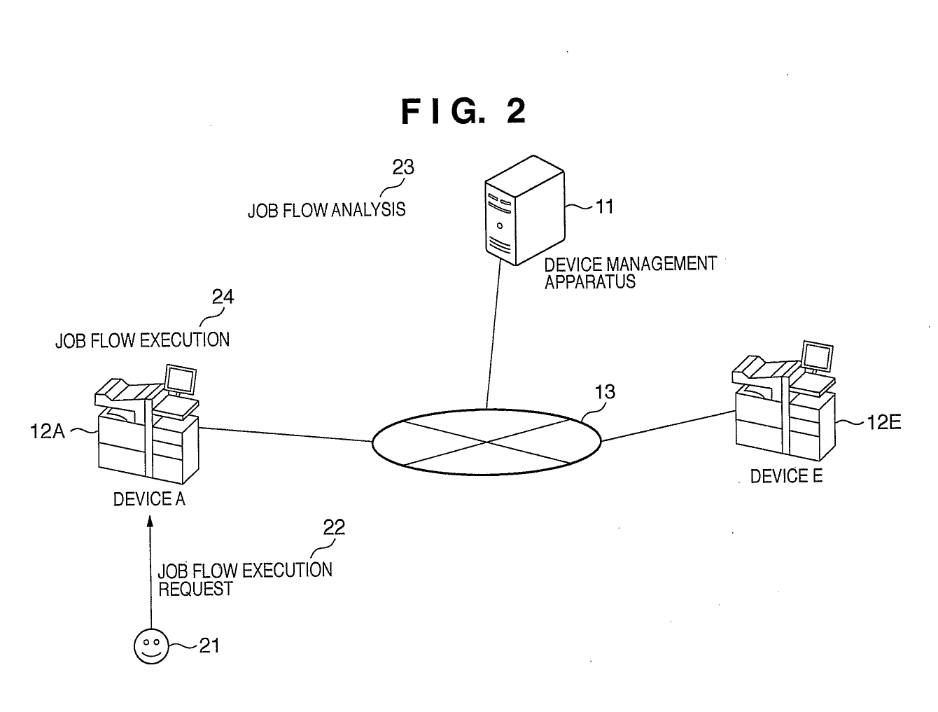

FIG. 2 shows an operation flow of a task cooperative processing system according to an embodiment of the present invention. When a user 21 makes a request 22 to execute a job flow, the device management apparatus 11 first analyzes the content of the job flow (job flow analysis 23), and starts executing the job flow (job flow execution 24) in response to the result of the analysis.

<Task Definition Information>

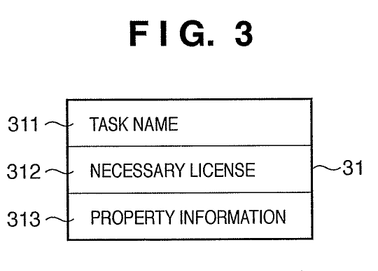

FIG. 3 shows task definition information according to the present invention. The task definition information 31 includes task name 311, license information 312 that is necessary to execute the task, and property information 313 that is necessary when executing the task. The license information 312 includes, for example, information indicative of the presence or absence of a license, the period of the license, and so on. Task definition information is defined for each task, and is saved in a task processing device that can execute the task. As used herein, “can execute a task” encompasses a case where the task can be executed if a license is assigned.

<Job Flow Definition Information>

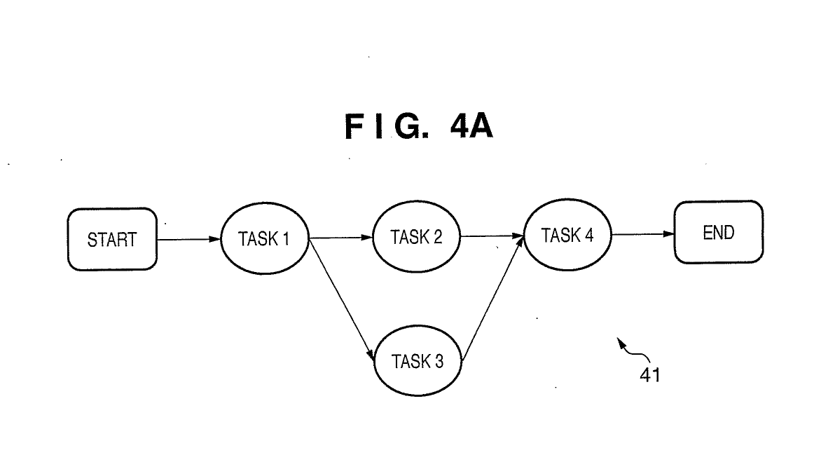

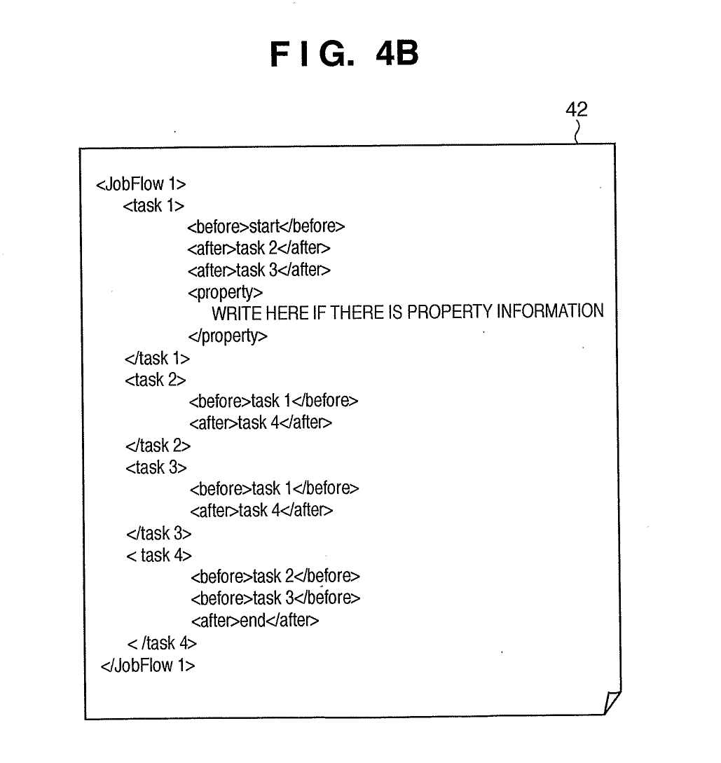

FIG. 4B shows an example of job flow definition information according to the present invention. The job flow definition information is created by, for example, computer dedicated software or the like, and is saved in a device management apparatus or task processing device. FIG. 4A shows an example of a job flow that is used to illustrate the job flow definition information according to the present invention. This example describes a job flow in which after Task 1 is executed, Tasks 2 and 3 are concurrently processed, after that, Task 4 is executed, and the flow ends. The job flow defines not only the order, but also the data delivered between tasks. For example, the output data of Task 1 serves as input data for Tasks 2 and 3. Likewise, the output data of Task 2 and that of Task 3 serve as input data for Task 4. As used herein, “concurrent process” and “to process concurrently” mean not only that tasks are executed simultaneously, but also that tasks can be executed in parallel. This does not imply that Tasks 2 and 3 must be executed concurrently, and Tasks 2 and 3 may be executed in series in this order (Task 2→Task 3) or in the opposite order as long as the relationship between data input and data output complies with the definition.

FIG. 4B shows job flow definition information written in XML format based on FIG. 4A. In the present embodiment, task tags are prepared in XML to define the task execution order, and the name of a task that is executed before a given task and that of a task that is executed after the given task are described. If information regarding task property is defined in task definition information, the information is written in a property tag. As used herein, “before” and “after” can be interpreted as terms that describe the relationship between data input and data output. Specifically, a <before> tag is a tag that defines the source of input data. Likewise, an <after> tag is a tag that defines the destination of output data. In job flow definition information, at least the order of all of the tasks that are to be executed in the job flow is written. The job flow definition information may be written in a format other than XML format as long as the order of tasks can be clearly defined.

The description given above applies to all of the embodiments that will be described below. Embodiment 1 will now be described based on the foregoing description.

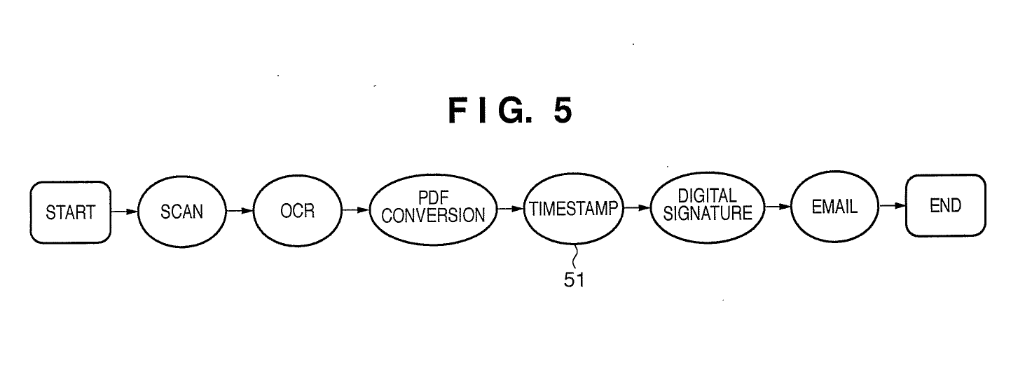

FIG. 5 shows an example of a job flow according to the present embodiment. This job flow starts with a scan task, and the scanned image data is processed using an OCR and converted into PDF. The converted document is timestamped, given a digital signature, and then sent by email.

<Device-Task Table>

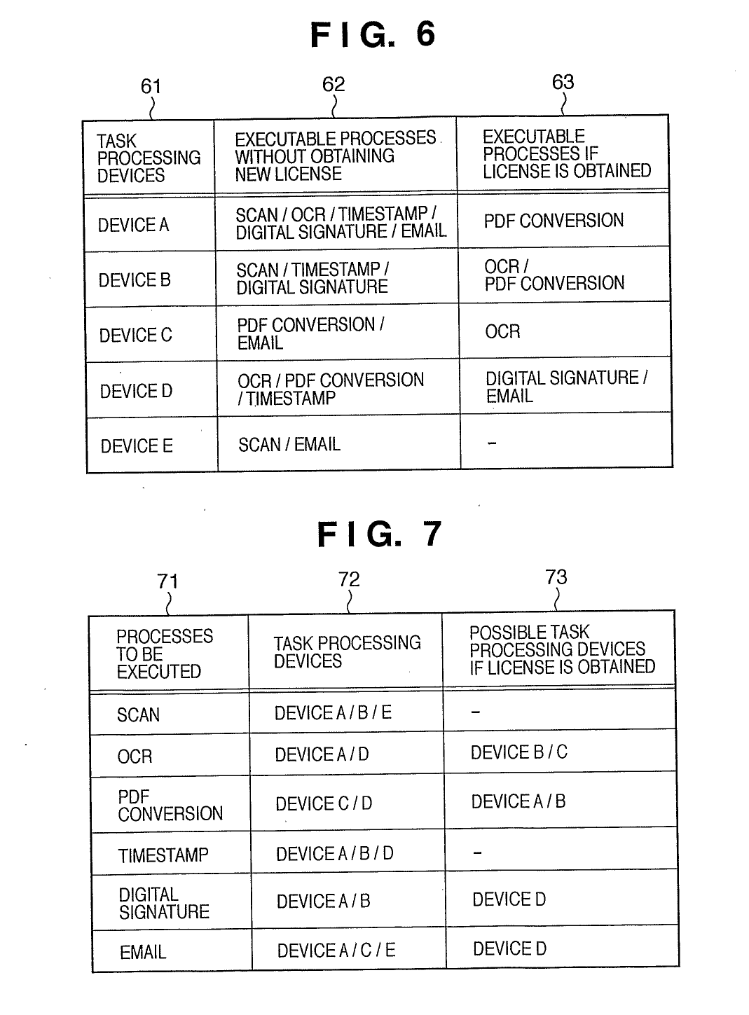

FIG. 6 is a device-task table that shows a list of task processing devices managed by the device management apparatus 11, the tasks performed by the task processing devices, and the license status. The device-task table is saved in the device management apparatus 11. The device-task table is created by, for example, based on information obtained by the device management apparatus 11 by requesting the task processing devices under management for information regarding their executable tasks. The device management apparatus does not necessarily have the device-task table itself, and it may have information that corresponds to the device-task table, that is, information indicative of task processing devices, tasks, and license status. The task license status includes a list 62 of executable processes (tasks) without obtaining a new license, and a list 63 of executable processes (tasks) if a license is obtained. “Task processing devices” 61 lists task processing devices that are managed by the device management apparatus 11. “Executable processes without obtaining a new license” 62 lists tasks that are available by the task processing devices since software and hardware resources have been installed, and the task licenses have been installed or are not necessary. “Executable processes if a license is obtained” 63 lists tasks that are not available since the task licenses are not issued to the task processing devices although resources other than the licenses have been installed. Take Device B for example, scanning, timestamping and digital signature function are available functions because Device B has these licenses, and OCR and PDF conversion functions are functions that can be executed if a license is obtained.

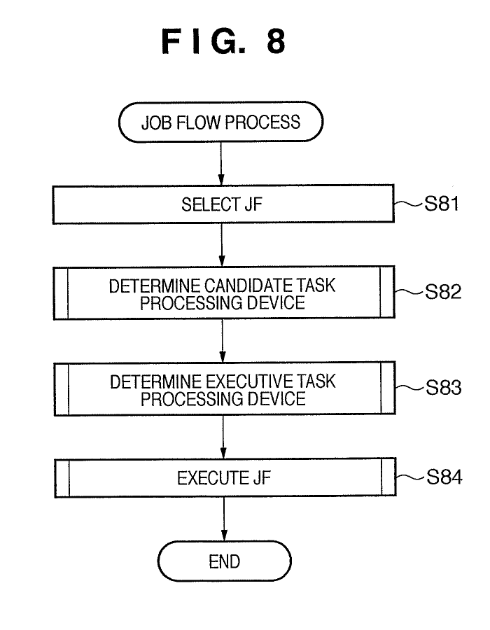

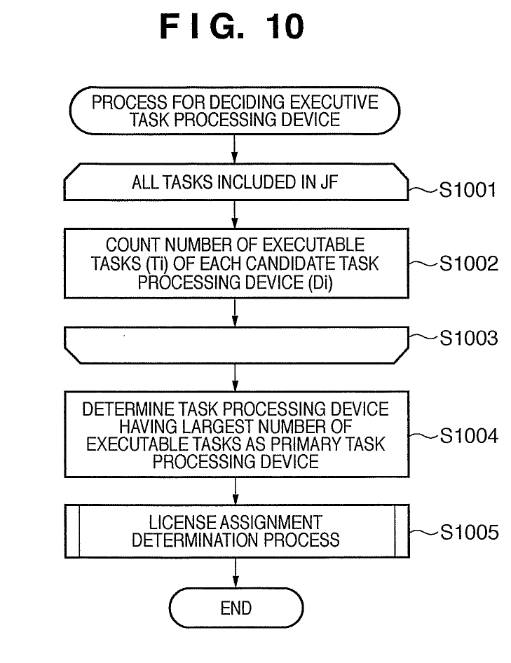

FIG. 7 is a candidate device list obtained based on the job flow shown in FIG. 5 and the status of task processing devices shown in FIG. 6, which shows a list of candidate task processing devices that can process each task of the job flow. The task processing devices listed in association with each task are candidate devices for executing the task. The candidate device list is created by the device management apparatus 11 according to the procedure of FIG. 9. “Processes to be executed” 71 lists tasks of the job flow to be executed in the present embodiment. “Task processing devices” 72 lists candidate task processing devices that can execute each task shown in “Processes to be executed” 71. These devices can execute the tasks without obtaining a new license. “Possible task processing devices if a license is obtained” 73 lists task processing devices that can execute the task if a license is installed into the task processing device. This is explained below taking the OCR task as an example. From the available task processing devices shown in the table of FIG. 6, it can be seen that Devices A 12A and D 12D are task processing devices that can execute the OCR task. It can also be seen that Devices B 12B and C 12C are task processing devices that can execute the OCR task if an OCR license is obtained. Accordingly, Devices A 12A and D 12D are listed in “Task processing devices” 72 as candidate devices for executing the OCR task, and Devices B 12B and C 12C are listed in “Possible task processing devices if a license is obtained” 73 as candidate devices that can execute the OCR task if a license is obtained.

<Process for Executing Job Flow>

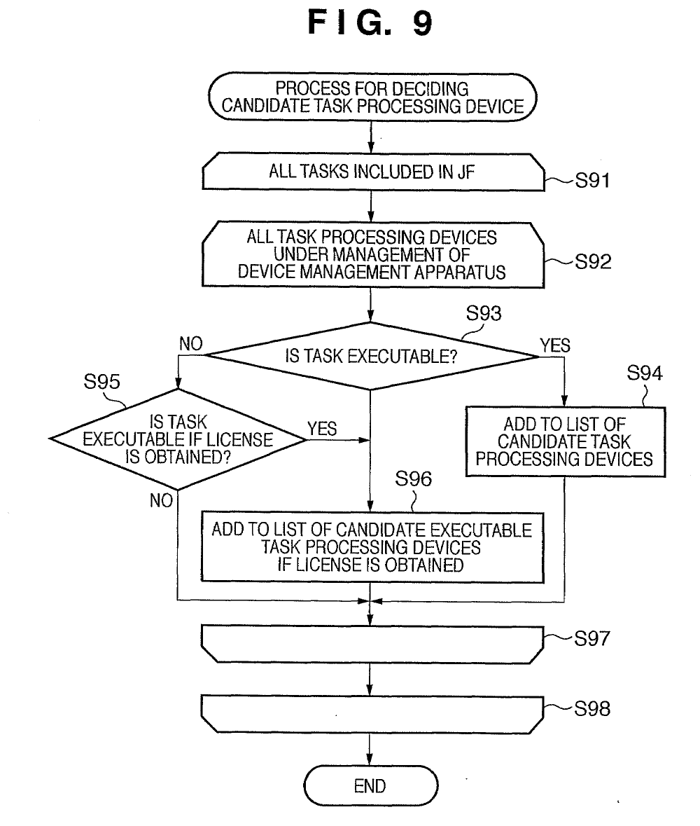

FIG. 8 shows an overall flow of a process for executing a job flow according to the present embodiment. When the process is started, the user first selects a job flow to be executed using an appropriate task processing device or device management apparatus (S81). The content of the selected job flow is transmitted to the device management apparatus 11, and candidates (hereinafter referred to as “candidate task processing devices”) for a task processing device to be used (hereinafter referred to as “executive task processing device”) are determined based on the device-task table (FIG. 6) (S82). Then, an executive task processing device that executes each task of the job flow is determined from among the candidate task processing devices (S83). The device management apparatus 11 schedules each task in accordance with the definition of the selected job flow such that the task is executed by the determined executive task processing device. For example, the device management apparatus 11 transmits an instruction to execute a task, and optionally, input data to a task processing device that executes the task, causes the device to execute the task, and receives output data if necessary. This is executed according to the task order defined in the job flow. However, if a single task processing device continuously executes tasks, the data is delivered by communication between the tasks within the task processing device. For this reason, the device management apparatus 11 can select, for example, whether to transmit input data itself or the address of the data together with an instruction to execute a task. As for output data, the device management apparatus 11 can select whether to return the data itself or the address at which the output data is saved. If data is delivered within a task processing device, with respect to a task that delivers the output data to another task of the same device, the device management apparatus 11 selects the designation of an address at which output data is saved, and transmits the address together with an execution instruction. With respect to a task that receives input data from another task of the same device, the device management apparatus 11 selects the designation of an address of input data, and transmits the address together with an execution instruction. In this way, when data is delivered between tasks within a single device, the need to transfer data is eliminated, it is therefore possible to reduce the transfer time. Of course, the method described above is only an example, and other methods can be used as long as data can be delivered directly between tasks when executing a set of tasks within a single task processing device. This is not limited to the device management apparatus, and applies to the case where the execution and management of a job flow is performed by a task processing device.

The job flow is executed by the executive task processing device thus selected (S84), and the process ends.

<Process for Deciding Candidate Task Processing Device>

FIG. 9 shows a flow of a process for determining (or selecting) candidate task processing devices for executing a task in step S82 of FIG. 8. When the process is started, the process ranging from steps S92 to S97 is performed for all of the tasks of the job flow by sequentially targeting each task (S91). In step S91, the identifier of the target task is written into “Processes to be executed” 71 of FIG. 7. Next, for each task, the process ranging from steps S93 to S96 is performed for all of the task processing devices that are under management of the device management apparatus 11 by sequentially targeting each device (S92).

In step S93, it is determined whether or not the target task can be executed. If the target task processing device can execute the target task, the target device is added as a candidate task processing device (S94). Specifically, in S94, the identifier of the target task processing device is additionally written into “Task processing devices” 72 of FIG. 7. If the target task processing device cannot execute the target task, it is determined whether or not the target task processing device can execute the target task if a license is obtained (S95). If so, the target device is added as a candidate task processing device that can execute the target task if a license is obtained (S96). Specifically, in S96, the identifier of the target task processing device is additionally written into “Possible task processing devices if a license is obtained” 73 of FIG. 7. If not, nothing is performed.

If there is a task processing device that has not been targeted yet, the next task processing device is set as a new target task processing device, and the process ranging from S93 to S96 is repeated (S97). If not, the process advances to S98. If there is a task that has not been targeted yet, the next task is set as a new target task, and the process ranging from S92 to S97 is repeated (S98). When the process described above has been performed for all of the tasks included in the job flow to be processed, this process finishes.

<Process for Deciding Executive Task Processing Device>

FIG. 10 is a flowchart of a process for determining an executive task processing device that executes a task in S83 of FIG. 8. When the process is started, the operation of S1002 is performed for all of the tasks of the job flow to be processed by sequentially targeting each task (S1001). In S1002, a counter Ti for counting the number of tasks corresponding to a candidate task processing device Di (1≦i≦the total number of task processing devices) that can process the target task performs counting by referring to the candidate device list of FIG. 7. Specifically, 1 is added to the counter Ti of the candidate task processing device Di that can process the target task. “Candidate task processing devices that can process the target task” means devices that can execute the target task without obtaining a new license, namely, the devices listed under the column 72 of FIG. 7. After the number of executable tasks has been counted for all of the tasks (S1003), the identifier of a task processing device Dmax that has the maximum counter value Tmax is saved as the identifier of a primary task processing device (S1004). Specifically, a task processing device that has the largest number of executable tasks is determined as a primary task processing device. Referring to FIG. 7, in the present embodiment, if D1 is Device A, D2 is Device B, D3 is Device C, D4 is Device D, and D5 is Device E, T1=5, T2=3, T3=2, T4=3, and T5=2. Accordingly, Device A is decided as a primary task processing device. Finally, a license assignment determination process is performed (S1005), and the process ends.

<License Assignment Determination Process>

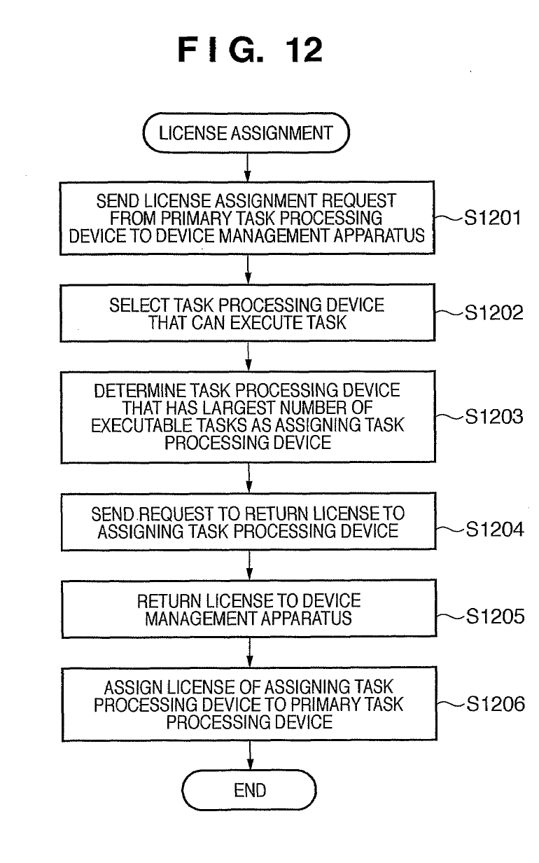

FIG. 11 shows a flow of a license assignment determination process in step S1005 of FIG. 10. When the process is started, it is determined whether or not there is a task that cannot be executed by the determined primary task processing device (S1101). If the primary task processing device can execute all of the tasks, the primary task processing device is determined as a task processing device that executes all of the tasks (S1102), and the process ends. When a task processing device that executes a task included in a job flow is determined, for example, a schedule is created in which the task is associated with the task processing device that executes the task. In this case, in S1102, a schedule is created in which all of the tasks of the job flow are associated with the primary task processing device.

If, on the other hand, there is a task that cannot be executed by the primary task processing device, the process ranging from S1104 to S1107 is executed for unexecutable tasks by sequentially targeting each unexecutable task (S1103). Meanwhile, tasks that can be executed by the primary task processing device are associated with the primary task processing device to create a schedule. Then, it is determined whether the target task can be executed if a license is obtained (S1104). If the target task cannot be executed even if a license is obtained, a task processing device that can execute the target task is decided as an executive task processing device (S1105), and the process moves on for the next target task (S1108). In this case, because the executive task processing device is not the primary task processing device, the target task is associated with the determined task processing device, and is added to the schedule.

If the target task is a task that can be executed if a license is obtained, a license assignment process is performed (S1106), and then the primary task processing device to which a license for the target task is assigned is determined as an executive task processing device (S1107). For example, the target task is associated with the primary task processing device, and is added to the schedule. Then, the process moves on for the next target task (S1108).

If all unexecutable tasks have been processed, this process ends. Referring to FIG. 7, Device A, which serves as a primary task processing device, cannot execute a PDF conversion task, but Device A can execute the PDF conversion task by obtaining the license. Because another task processing device managed by the device management apparatus 11 can execute the PDF conversion task, a license assignment process is performed to transfer the license from that task processing device to the primary task processing device.

<License Assignment Process>

FIG. 12 shows a flow of a license assignment process in S1106 of FIG. 11. When the process is started, the primary task processing device sends a license assignment request to the device management apparatus 11 (S1201) In the present embodiment, the process of FIG. 12 is executed by the device management apparatus. Further, if the process of FIG. 10 is executed by a task processing device that has been instructed to execute the job flow, the task processing device is not necessarily a primary task processing device. If the process of FIG. 12 is not executed by the primary task processing device, a device that performs the process of FIG. 12, for example, the device management apparatus, informs the primary task processing device of a task for which the primary processing device needs to obtain a license. In response thereto, the primary task processing device sends a license assignment request to the device management apparatus 11.

Upon receiving the license assignment request, the device management apparatus 11 selects (or extracts) task processing devices to which the task license has been assigned (S1202), and determines a task processing device that has the maximum number of executable tasks from among the selected task processing devices, and determines it as an assigning task processing device (S1203). Referring to FIGS. 6 and 7, in the present embodiment, the task processing devices that are selected in S1202 are Devices C and D whose number of executable tasks are 2 and 3, respectively. Accordingly, Device D is determined as an assigning task processing device in S1204. After the assigning task processing device is determined, the device management apparatus 11 sends a request to return the task license for executing the task to the assigning task processing device (S1204). Upon receiving the request, the assigning task processing device returns the task license to the device management apparatus 11 (S1205). The device management apparatus 11 assigns the returned license to the primary task processing device (S1206), and terminates the process. The license includes information that indicates that it is a license for allowing a device to execute a specified task. Such information may be any information as long as a program or device that executes the task can recognize it as a license.

<Process for Executing Job Flow>

FIG. 13 shows a flow of a process for executing a job flow in S84 of FIG. 8. The process of FIG. 13 is not executed by a single apparatus (or device), and FIG. 13 collectively shows processes performed by a plurality of apparatuses (or devices). When the process of FIG. 13 is started, the tasks of the job flow are sequentially targeted (S1301), and each target task is executed by a task processing device determined as the executive task processing device that executes the target task (S1302). This is repeated for all of the tasks (S1303). In the present embodiment, the job flow is scheduled by the device management apparatus, and thus the device management apparatus controls the task processing devices in accordance with the schedule. Specifically, in the process ranging from S1301 to S1303, the device management apparatus 11 transmits input data and an instruction to execute a task to each executive task processing device, and the executive task processing device that has received them executes the task. In this case, the device management apparatus 11 transmits input data (optionally) and an instruction to execute a task based on the schedule in which the tasks of the job flow are associated with the corresponding executive task processing devices. This is, of course, only an example, so that if the job flow is managed by one of the task processing devices rather than by the device management apparatus 11, for example, that task processing device executes the process ranging from S1301 to S1303.

After the execution of each task, it is determined whether or not the license of the executive task processing device is an assigned license (S1304). If the license is not an assigned license, the process ends. If the license is an assigned license, the executive task processing device that has the assigned license returns the assigned license to the device management apparatus 11 (S1305). This process is performed by each executive task processing device. In FIG. 13, the license return process is performed after the entire job flow has been executed, but if individual task processing devices return the licenses, the task license return process may be performed each time the task is finished.

The device management apparatus 11 that has received the license from the executive task processing device returns the returned license to the original assigning task processing device (S1306), and terminates the process.

In the present embodiment, the license for PDF conversion task is assigned from Device D to Device A. Accordingly, Device A returns the license to the device management apparatus 11 after the PDF conversion task is finished, and the device management apparatus 11 returns the license to Device D.

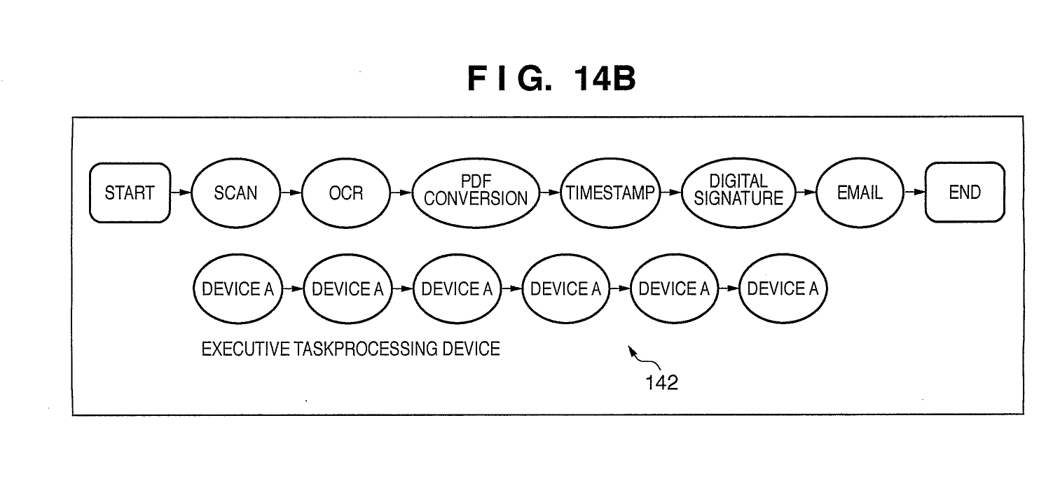

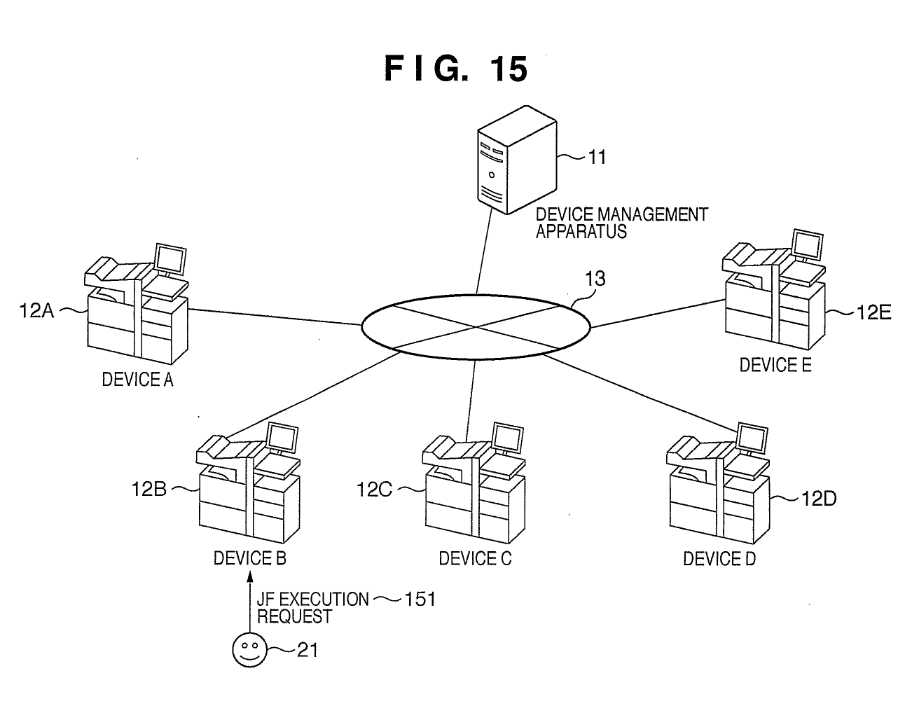

FIG. 14B shows an example of the result obtained from application of the process according to the present embodiment. FIG. 14A illustrates executive task processing devices when a job flow is executed according to a conventional technique, and FIG. 14B illustrates executive task processing devices when the job flow is executed according to the present embodiment.

According to a conventional technique, the tasks of a job flow are executed by task processing devices that can execute corresponding tasks. Accordingly, only the PDF conversion task needs to be executed by Device B. According to the present embodiment, on the other hand, the license for PDF conversion task possessed by Device B is temporarily assigned to Device A. This enables Device A to execute all of the tasks of the job flow, and therefore the entire job flow can be executed by Device A. When a plurality of tasks are continuously executed by a single task processing device as in the case described above, the data is delivered within the device. Accordingly, overhead for data transfer is eliminated, so that the job flow can be executed efficiently, and communication traffic within the task cooperative processing system can be made small.

### EMBODIMENT 2

Embodiment 2 of the present invention will be described. The present embodiment shows another example for determining an executive task processing device that is different from Embodiment 1. In Embodiment 1, an example has been shown in which a task processing device that has the largest number of executable tasks is set as a primary task processing device. In the present embodiment, an example will be described in which a task processing device that is being operated by the user is set as a primary task processing device.

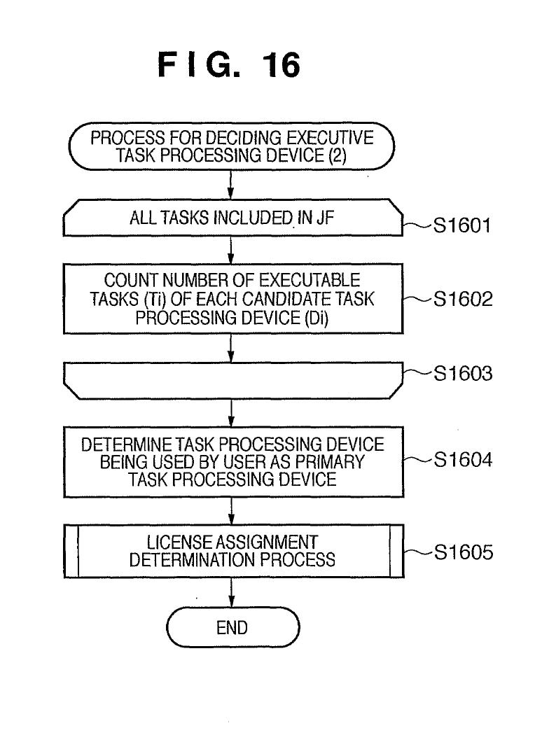

FIG. 15 shows an overall configuration according to the present embodiment. Other figures are the same as those of Embodiment 1, except that FIGS. 1 and 10 of Embodiment 1 are replaced by FIGS. 15 and 16, respectively.

The present embodiment shows an example in which a user 21 provides a request (indicated by reference numeral 151) to execute a job flow with Device B. In Embodiment 1, a task processing device that is operated by the user is not specified, whereas the present embodiment considers a task processing device that is operated by the user.

<Process for Determining Executive Task Processing Device>

FIG. 16 shows a flow of a process for determining a task processing device that executes a task according to the present embodiment. The candidate task processing devices have been determined according to the procedure of FIG. 9. FIG. 16 shows a flow of a process for determining an executive task processing device that executes a task in S83 of FIG. 8. When the process is started, S1602 is performed for all of the tasks of the job flow to be processed by sequentially targeting each task (S1601). In S1602, a counter Ti for counting the number of tasks corresponding to a candidate task processing device Di (1≦i≦the total number of task processing devices) that can process the target task performs counting by referring to the candidate device list of FIG. 7. Specifically, 1 is added to the counter Ti of the candidate task processing device Di that can process the target task. “Candidate task processing devices that can process the target task” means devices that can execute the target task without obtaining a new license, namely, the devices listed under the column 72 of FIG. 7. After the number of executable tasks has been counted for all the tasks (S1603), the task processing device that is being used by the user is decided as a primary task processing device (S1604). In this example, Device B is determined as a primary task processing device. Finally, a license assignment determination process is performed (S1605), and the process ends. The license assignment determination process is the same as that shown in FIG. 11 of Embodiment 1.

Referring to FIG. 6, in the present embodiment, the tasks that Device B, which serves as a primary task processing device, cannot execute are an OCR task, a PDF conversion task, and an email task. These tasks except the email task can be executed by another task processing device that is managed by the device management apparatus 11. Therefore, for the OCR and PDF conversion tasks, a license assignment process is executed.

Taking the license assignment process flow shown in FIG. 12 as an example by referring to FIG. 7, a license assignment process for each task is performed as follows.

For the OCR task, Devices A and D are extracted as task processing devices that can execute the OCR task. Because Device A has more executable tasks than Device D, Device A assigns the OCR license to Device B.

Similarly, Devices C and D are extracted as task processing devices that can execute the PDF conversion task. Because Device D has more executable tasks than Device C, Device D assigns the PDF conversion license to Device B.

Meanwhile, the email task cannot be executed by Device B even if the license is installed on Device B, and thus will be executed by another task processing device that can execute the email task.

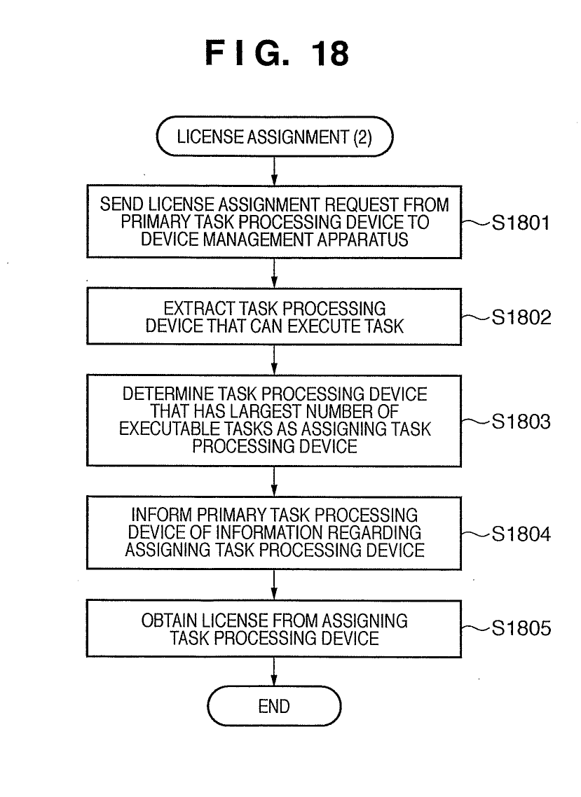

FIG. 17 shows an example of the result obtained from application of the job flow process according to the present embodiment. Because the OCR license of Device A and the PDF conversion license of Device D are temporarily assigned to Device B, Device B processes all of the tasks of the job flow except the email task, and the email task is executed by Device A.

With this configuration, according to the present embodiment, the effect of Embodiment 1 can be obtained, and in addition thereto, the time during which a task processing device that is not operated by a user is occupied by the user can be made shorter than Embodiment 1. This can suppress the occurrence of an event in which a user is hardly aware of a situation, as in the case where a device is used by another user, and not available, although the device appears not to be in use by anyone.

### EMBODIMENT 3

Embodiment 3 of the present invention will be described. The present embodiment shows another system for license assignment and job flow execution that is different from those of Embodiments 1 and 2. Accordingly, other configuration and processes are the same as those of Embodiment 1. Embodiments 1 and 2 have shown examples in which the license assignment process and the license return process are performed via the device management apparatus 11. In the present embodiment, an example will be described in which those processes are performed between task processing devices.

<License Assignment Process>

FIG. 18 shows a flow of a license assignment process according to the present embodiment. This is an alternative to that of FIG. 12 of Embodiment 1. When the process is started, the primary task processing device sends a license assignment request to the device management apparatus 11 (S1801). Similar to Embodiment 1, the process of FIG. 18 according to the present embodiment is executed by the device management apparatus. Further, if the process of FIG. 10 is executed by a task processing device that has been instructed to execute the job flow, the task processing device is not necessarily a primary task processing device. If the process of FIG. 18 is not executed by the primary task processing device, a device that performs the process of FIG. 18, for example, the device management apparatus, informs the primary task processing device of a task for which the primary processing device needs to obtain a license. In response thereto, the primary task processing device sends a license assignment request to the device management apparatus 11.

Upon receiving the license assignment request, the device management apparatus 11 selects (or extracts) task processing devices to which the task license has been assigned (S1802), and determines a task processing device that has the maximum number of executable tasks from among the selected task processing devices, and determines it as an assigning task processing device (S1803) Referring to FIGS. 6 and 7, in the present embodiment, the task processing devices that are selected in S1802 are Devices C and D whose number of executable tasks are 2 and 3, respectively. Accordingly, Device D is determined as an assigning task processing device in S1804. After the assigning task processing device is determined, the device management apparatus 11 communicates information regarding the assigning task processing device to the primary task processing device (S1804). Upon receiving the information, the primary task processing device sends a request to assign a license for the task to the assigning task processing device, receives the license from the assigning task processing device that has received the request, and obtains the license by installing it (S1805). Then, the process ends.

<Process for Executing Job Flow>

FIG. 19 shows a flow of a process for executing a job flow according to the present embodiment. The process of FIG. 19 is an alternative to that of FIG. 13 of Embodiment 1. The process of FIG. 19 is not executed by a single apparatus (or device), and FIG. 19 collectively shows processes performed by a plurality of apparatuses (or devices). When the process of FIG. 19 is started, the tasks of the job flow are sequentially targeted (S1901), and each target task is executed by a task processing device determined as the executive task processing device that executes the target task (S1902). This is repeated for all of the tasks (S1903). In the present embodiment, the job flow is scheduled by the device management apparatus, and thus the device management apparatus controls the task processing devices in accordance with the schedule. Specifically, in the process ranging from S1901 to S1903, the device management apparatus 11 transmits input data and an instruction to execute a task to each executive task processing device, and the executive task processing device that has received them executes the task. In this case, the device management apparatus 11 transmits input data (optionally) and an instruction to execute a task based on the schedule in which the tasks of the job flow are associated with the corresponding executive task processing devices. This is, of course, only an example, so that if the job flow is managed by one of the task processing devices rather than by the device management apparatus 11, for example, that task processing device executes the process ranging from S1901 to S1903.

After the execution of each task, it is determined whether or not the license of the executive task processing device is an assigned license (S1904). If the license is not an assigned license, the process ends. If the license is an assigned license, the executive task processing device that has the assigned license returns the assigned license to the original assigning task processing device (S1905). This process is performed by each executive task processing device. In FIG. 19, the license return process is performed after the entire job flow has been executed, but if individual task processing devices return the licenses, the task license return process may be performed each time the task is finished.

In the present embodiment, the license for PDF conversion task is assigned from Device D to Device A. Accordingly, Device A returns the license to the device management apparatus 11 after the PDF conversion task is finished, and the device management apparatus 11 returns the license to Device D.

With this configuration, according to the present embodiment, it is possible to reduce traffic and time required for license transfer, and thus the processing efficiency can be further improved.

### EMBODIMENT 4

Embodiment 4 of the present invention will be described. The present embodiment shows another system for license assignment determination process that is different from that of Embodiment 2.

In Embodiment 2, an example has been shown in which a license is obtained from a task processing device that has the largest number of executable tasks. In the present embodiment, an example will be described in which a license is obtained from a task processing device that has the largest number of necessary task licenses. The process for determining a task processing device that executes a task of the present embodiment is the same as that shown in FIG. 16 of Embodiment 2. Referring to FIGS. 15 and 6, if D1 is Device A, D2 is Device B, D3 is Device C, D4 is Device D, and D5 is Device E, T1=5, T2=3, T3=2, T4=3 and T5=2. Accordingly, Device B in which an operation to execute a job flow is performed is decided as a primary task processing device.

<License Assignment Determination Process>

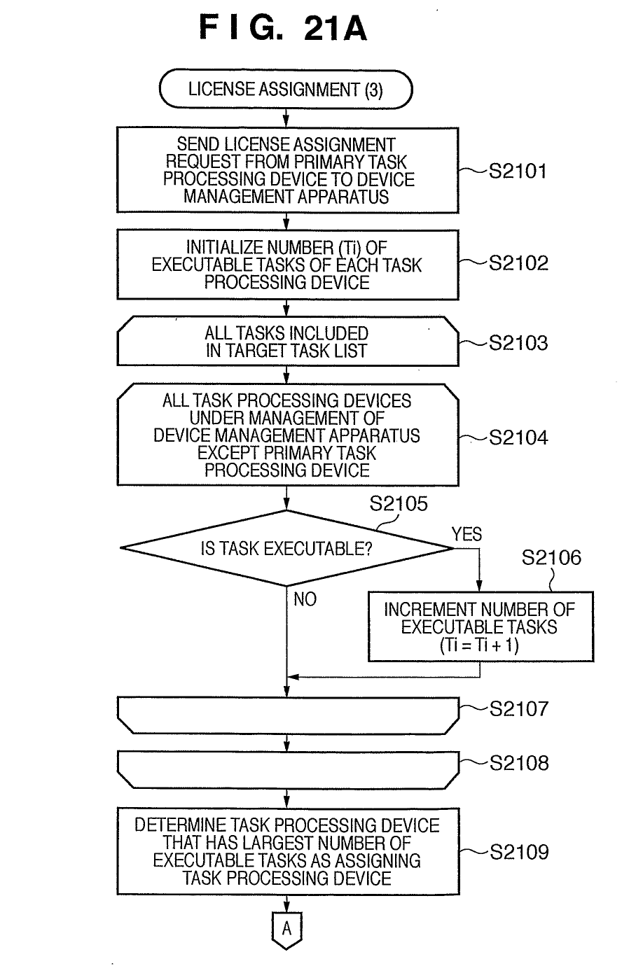

FIG. 20 shows a flow of a license assignment determination process according to the present embodiment. The process of FIG. 20 is an alternative to that of FIG. 11 of Embodiment 2. When the process is started, it is determined whether or not there is a task that cannot be executed by the decided primary task processing device (S2001). If the primary task processing device can execute all of the tasks, the primary task processing device is determined as a task processing device that executes all of the tasks (S2002), and the process ends. If, on the other hand, there is a task that cannot be executed by the primary task processing device, the process ranging from S2004 to S2007 is executed for unexecutable tasks by sequentially targeting each unexecutable task (S2003). First, it is determined whether or not the target task can be executed if a license is obtained (S2004). If the target task cannot be executed even if a license is obtained, a task processing device that can execute the target task is determined as an executive task processing device, and the process moves on for the next target task (S2008). If the target task is a task that can be executed if a license is obtained, the target task is added to a target task list (S2006), and the primary task processing device is determined as an executive task processing device (S2007). After that, the process moves on for the next target task (S2008). If all target tasks have been processed, a license assignment process is performed (S2009), and this process ends (S2010).

Referring to FIG. 6, in the present embodiment, the tasks that Device B, which serves as a primary task processing device, cannot execute are an OCR task, a PDF conversion task, and an email task. These tasks except the email task can be executed by another task processing device that is managed by the device management apparatus 11. Accordingly, the OCR task and the PDF conversion task are added to the target task list.

<License Assignment Process>

FIGS. 21A and 21B show a flow of a license assignment process in step S2009 of FIG. 20. When the process is started, the primary task processing device sends a license assignment request to the device management apparatus 11 (S2101). Next, the number of executable tasks (Ti: 1≦i≦the total number of task processing devices−1) of the task processing devices except the primary task processing device is initialized to 0 (S2102). The process ranging from S2104 to S2107 is executed for all of the tasks of the target task list determined according to the process flow shown in FIG. 20 by sequentially targeting each task. In S2104, all of the task processing devices except the primary task processing device are sequentially targeted, and it is determined whether or not the target task can be executed (S2105). If the target task can be executed, the number of executable tasks Ti is incremented (Ti=Ti+1) (S2106).

For each task of the target task list, the process ranging from S2105 to S2106 is performed for each task processing device, and then a task processing device having the maximum number of executable tasks is determined as an assigning task processing device that assigns a license (S2109). The assigning task processing device returns the licenses of tasks to be assigned to the device management apparatus 11 (S2110). If the license assignment process (3) is executed by the device management apparatus, the determination made in S2109 and the identifiers of the tasks whose license is to be assigned are communicated from the device management apparatus to the assigning task processing device. In response thereto, the assigning task processing device returns the licenses to the device management apparatus. Upon receiving the licenses, the device management apparatus 11 assigns the licenses to the primary task processing device (S2111).

Next, it is determined whether or not all of the tasks in the target task list can be executed by the primary task processing device (S2112). If the primary task processing device can execute all of the tasks, the process ends. If there are unexecutable tasks, one of the unexecutable tasks is targeted. Then, a task processing device that can execute the target task and have the largest number of executable tasks is determined as a license-assigning task processing device (S2113). The number of executable tasks can be obtained from a value obtained by counting of S2106. Then, the license assignment process S2114, S2115 is performed in the same manner as in S2110, S2111. The process ranging from S2112 to S2115 is repeated until all of the tasks of the target task list can be made executable by the primary task processing device.

Referring to FIG. 6, in the present embodiment, the tasks included in the target task list are an OCR task and a PDF conversion task. The number of executable tasks of each task processing device is Device A:1, Device C:1, Device D:2, and Device E:0. Accordingly, Device D is determined as the assigning task processing device. With the licenses moved from Device D to the primary task processing device, the primary task processing device can execute all of the tasks included in the target task list. After the OCR license and the PDF conversion license have been assigned from Device D to the device management apparatus 11, this process ends.

With this configuration, according to the present embodiment, even when licenses are assigned, the number of assigning devices can be reduced. Consequently, it is possible to suppress overhead for license transfer, and an efficient job flow process can be achieved.

### EMBODIMENT 5

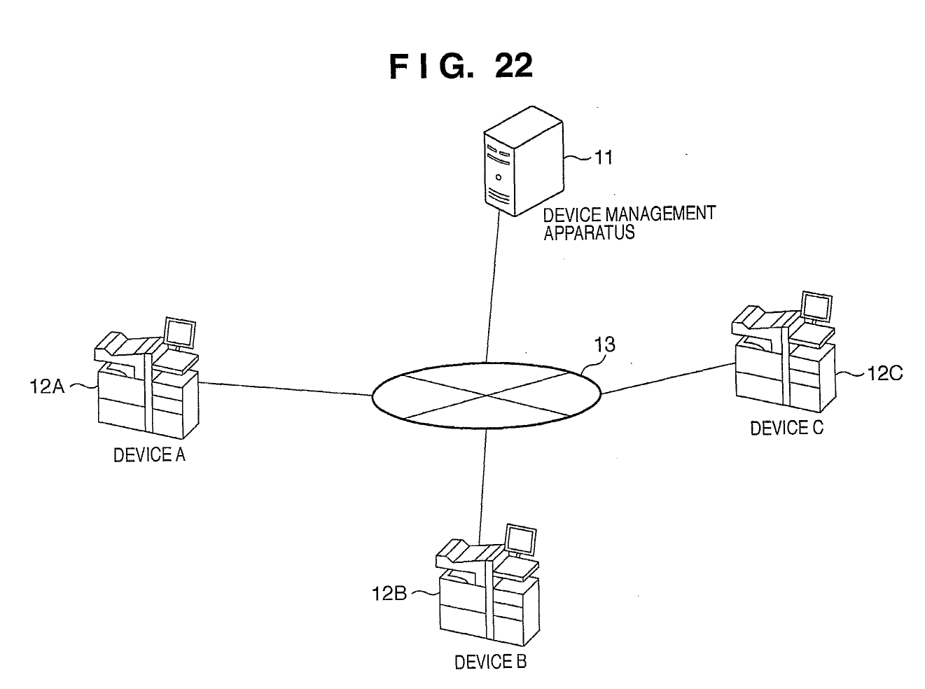

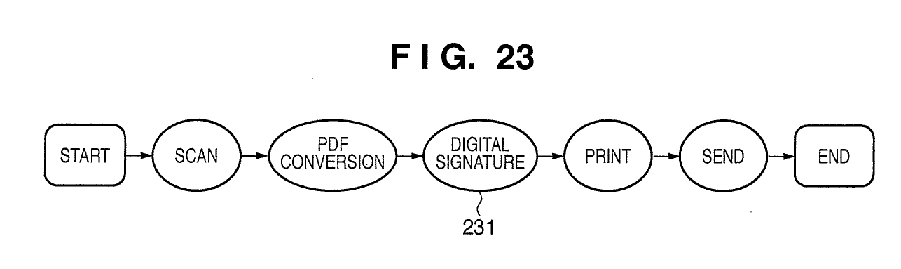

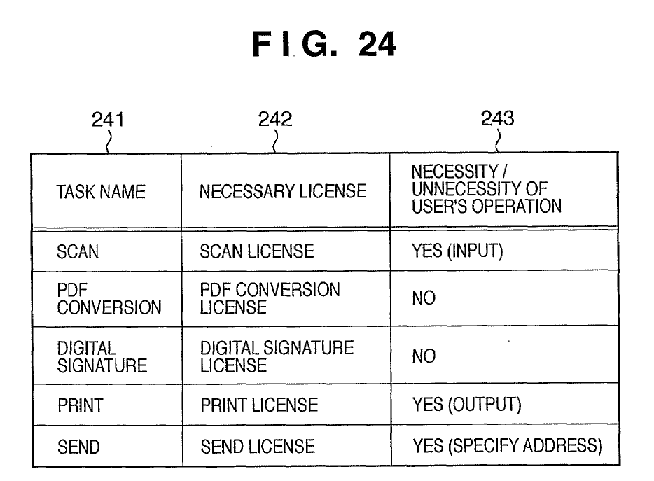

Embodiment 5 of the present invention will be described. FIG. 22 shows an overall configuration according to the present embodiment. The task processing devices that are managed by the device management apparatus 11 in the present embodiment are Devices A to C. FIG. 23 shows an example of a job flow according to the present embodiment. This job flow starts with a scan task, followed by PDF conversion, attachment of a digital signature, printing and sending. FIG. 24 is a table obtained based on the task definition information of each task of the job flow shown in FIG. 23 of the present embodiment.

In the present embodiment, information regarding whether or not a user's operation is necessary to execute each task is included. From the table, it can be seen that the scan task, print task and send task require a user's operation. This information can be held by, for example, each task as a property. In other words, the table of FIG. 24 can be obtained by collecting task definition information as shown in FIG. 3 of plural tasks.

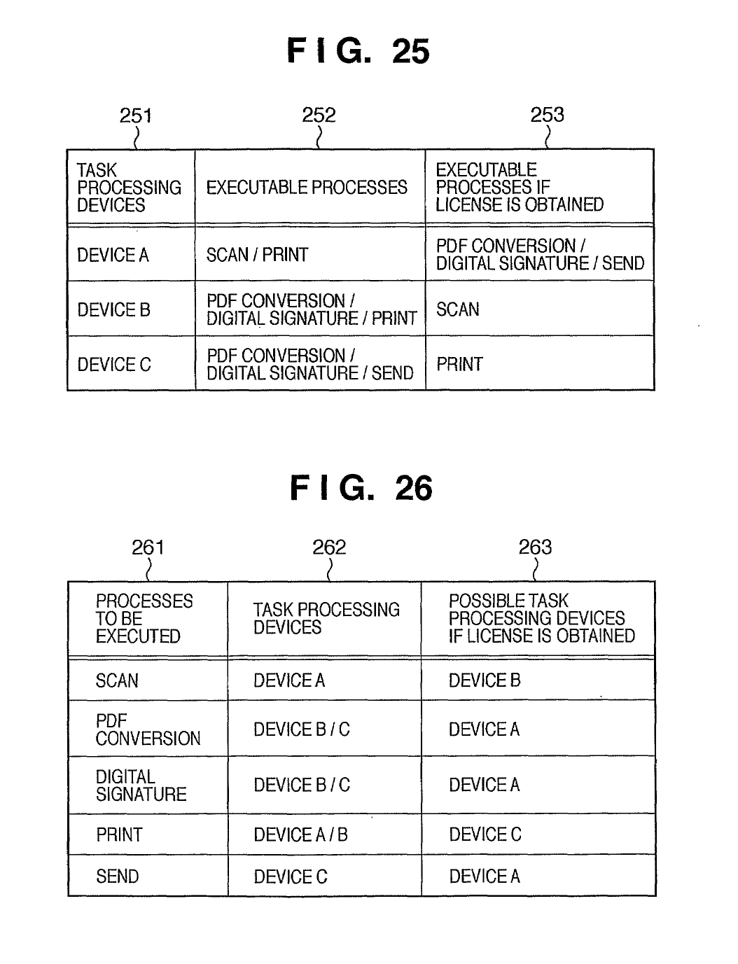

FIG. 25 shows a list of task processing devices that are managed by the device management apparatus 11, the license states thereof, and the status of installed applications. The license status refers to information for identifying an executable task, and the status of installed applications refers to information for identifying a task that can be executed if a license is obtained.

“Task processing devices” column 251 lists task processing devices that are managed by the device management apparatus 11. “Executable processes” column 252 lists functions that are available since the applications and the licenses have been installed in the task processing devices. “Executable processes if a license is obtained” column 253 lists tasks that are not available since licenses for executing the functions are not installed although the functions have been installed.

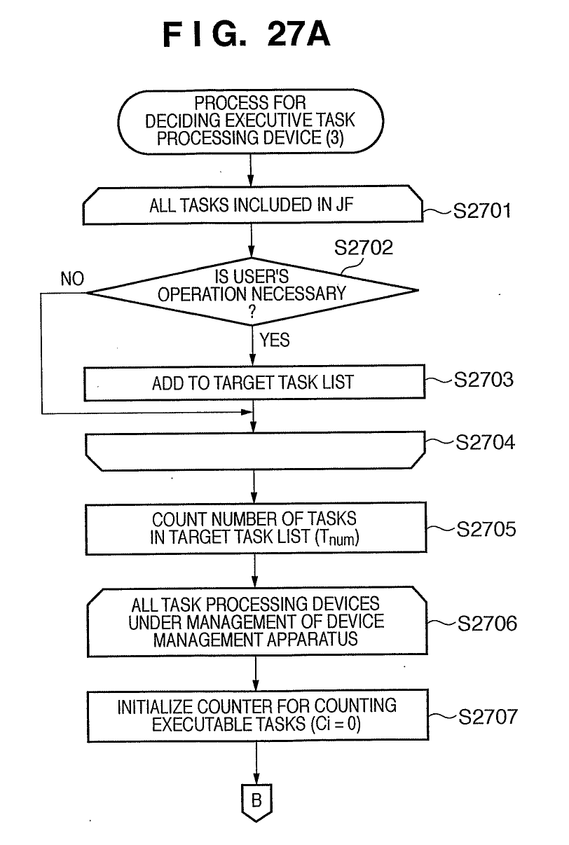

FIG. 26 shows a list of candidate task processing devices that can process each task of a job flow based on the job flow shown in FIG. 23 and the status of task processing devices shown in FIG. 25. “Processes to be executed” column 261 lists tasks that are processed in the present embodiment. “Task processing devices” column 262 lists candidate task processing devices that can execute the task shown in “Processes to be executed” column 261. “Possible task processing devices if license is obtained” column 263 lists task processing devices that can execute the task if a license is installed to the task processing device.

The overall flow of the process of the present embodiment is the same as that of FIG. 8, and the process for determining a candidate task processing device that can execute a task is the same as that of FIG. 9. FIGS. 27A to 27B show a flow of a process for determining a task processing device that executes a task of the present embodiment. FIGS. 27A to 27B are executed instead of FIG. 9 of Embodiment 1.

When the process is started, the process ranging from S2702 to S2703 is performed for all of the tasks of the job flow (S2701). First, it is determined whether or not a user's operation is necessary to process the target task by referring to the property of the task definition information (S2702). If a user's operation is unnecessary, the process moves on for the next task (S2704). If a user's operation is necessary for a target task, the target task is added to the target task list (S2703). After all of the tasks have been processed, the number Tnum of tasks in the target task list is counted (S2705). Referring to FIG. 24, in the present embodiment, the tasks in the target task list are scan, print and send tasks, so that Tnum is 3.

Next, the process ranging from S2707 to S2712 is processed for all of the task processing devices under management of the device management apparatus 11 by sequentially targeting each device (S2706). First, the counter Ci (1≦i≦the total number of task processing devices) for counting the number of tasks that the target task processing device i can execute is initialized to 0 (S2707). Then, the process ranging from S2709 to S2710 is performed for all of the tasks of the target task list by sequentially targeting each task (S2708). First, it is determined whether or not the target task is executable irrespective of presence or absence of the license of the task processing device (S2709). If the target task is not executable, the process moves on for the next task (S2711). If the target task is executable, the counter Ci for counting the number of executable tasks is incremented (Ci=Ci+1) (S2710). When all of the tasks have been processed, it is determined whether or not the counter Ci for counting the number of tasks that can be executed by the target task processing device i and the number Tnum of tasks of the target task list are equal (S2712). If the values are equal, instead of moving on for the next task processing device, the task processing device i is determined as a primary task processing device (S2714), and the process advances to S2716. If the values are not equal, the process ranging from S2707 to S2712 is repeated by targeting the next task processing device.

When all of the tasks processing devices have undergone the process ranging from S2707 to S2712, a task processing device having the largest number Ci of executable tasks is determined as a primary task processing device (S2715), and the process after S2716 is performed. Referring to FIG. 25, in the present embodiment, the number of executable tasks of Device A is 3, which is equal to Tnum. Accordingly, only Device A undergoes the process ranging from S2707 to S2713. Finally, a license assignment determination process is performed (S2716), and the process ends.

The license assignment determination process of the present embodiment is the same as that of FIG. 11 or 20. Similarly, the license assignment process is the same as that of FIG. 12 or 18 when the license assignment determination process is the same as that of FIG. 11, and when the license assignment process is the same as that of FIG. 20, the license assignment process is the same as that of FIGS. 21A to 21B. To describe the present embodiment taking the case where the license assignment determination process of FIG. 20 and the license assignment process of FIGS. 21A to 21B are used, the tasks that Device A, which serves as a primary task processing device, cannot execute are a PDF conversion task, a digital signature task, and a send task. The licenses of all these tasks are assigned from Device C. With the above process, all of the tasks of the job flow shown in FIG. 23 are executed by Device A, so that the job flow can be executed efficiently.

As described above, according to the present embodiment, the number of task processing devices that execute tasks that require a user's operation included in a job flow can be reduced. Accordingly, the movement of the user during execution of the job flow can be reduced, and thus the processing efficiency can be further improved.

### EMBODIMENT 6

Embodiment 6 of the present invention will be described. The present embodiment shows another system for license assignment determination process that is different from that (S2716) of Embodiment 5. The present embodiment describes a case where a task is more efficiently executed without a license assignment process than with the license assignment process.

The present embodiment assumes that Device A shown in FIG. 22 can operate a send task only in monochrome, whereas the send task of the job flow is set in color.

<License Assignment Determination Process>

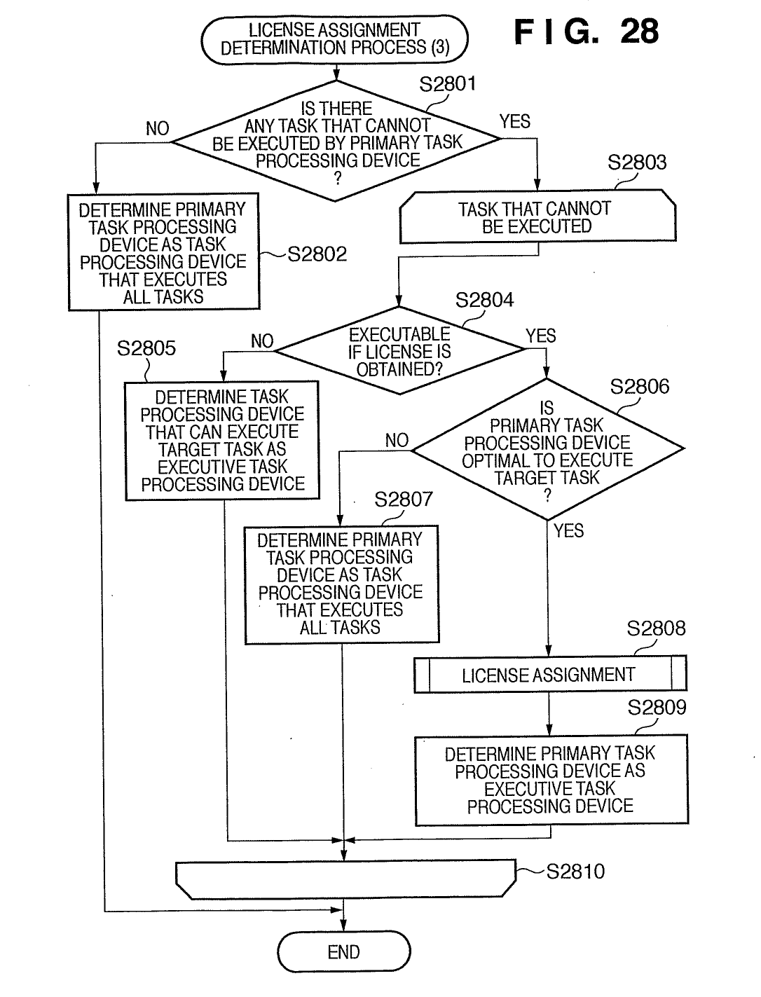

FIG. 28 shows a flow of a license assignment determination process according to the present embodiment. The process of FIG. 28 is an alternative to that of FIG. 11 of Embodiment 1. When the process is started, it is determined whether or not there is a task that cannot be executed by the determined primary task processing device (S2801). If the primary task processing device can execute all of the tasks, the primary task processing device is determined as a task processing device that executes all tasks (S2802), and the process ends. When a task processing device that executes a task included in a job flow is decided, for example, a schedule is created in which the task is associated with the task processing device that executes the task. In this case, in S2802, a schedule is created in which all of the tasks of the job flow are associated with the primary task processing device.

If, on the other hand, there is a task that cannot be executed by the primary task processing device, the process ranging from S2804 to S2809 is executed for unexecutable tasks by sequentially targeting each unexecutable task (S2803). Meanwhile, tasks that can be executed by the primary task processing device are associated with the primary task processing device to create a schedule. Then, it is determined whether the target task can be executed if a license is obtained (S2804). If the target task cannot be executed even if a license is obtained, a task processing device that can execute the target task is decided as an executive task processing device (S2805), and the process moves on for the next target task (S2810). In this case, because the executive task processing device is not the primary task processing device, the target task is associated with the determined task processing device, and is added to the schedule.

If the target task is a task that can be executed if a license is obtained, it is determined whether or not the primary task processing device is optimal to execute the target task (S2806). If the primary task processing device is not optimal to execute the target task, a task processing device that can execute the task is determined as an executive task processing device (S2807), and the process moves on for the next target task (S2810). If the primary task processing device is optimal to execute the task, a license assignment process is performed (S2808), and the primary task processing device to which the license of the target task is assigned is determined as an executive task processing device (S2809). For example, the target task is associated with the primary task processing device, and is added to the schedule. Then, the process moves on for the next target task (S2810).

If all unexecutable tasks have been processed, this process ends. Referring to FIG. 25, in the present embodiment, the tasks that Device A, which serves as a primary task processing device, cannot execute are a PDF conversion task, a digital signature task, and a send task. When these tasks and the state of Device A are checked, it can be seen that Device A cannot process the send task optimally as assumed above. Accordingly, Device A receives the license of the PDF task and that of the digital signature task from Device C, and the send task is executed by Device C that can execute the send task.

The conditions for not performing a license assignment process are not limited to this example. There is no limitation as long as a job flow is more efficiently executed without a license assignment process than with the license assignment process. Optimal conditions for executing a task may be written, for example, in the property tag of the task definition information. In this case, in step S2804, the property of the target task included in the job flow and the property of the task executed by the primary task processing device are collated to determine whether or not they are the same.

An Example of the Invention Extracted from Embodiments

In the embodiments given above, the best modes for carrying out the invention have been described, but the above embodiments do not necessarily describe only the essential items for configuring the invention.

The present invention may be applied to a system configured of a plurality of devices (e.g., a host computer, an interface device, a reader, a printer, and so on) or to an apparatus configured of a single device (e.g., a copy machine, a facsimile device, and so on). The object of the present invention is also achieved by supplying a recording medium, in which program code that implements the functions of the foregoing embodiments is recorded, to a system or apparatus, loading the program code stored in the storage medium into a computer of the system or apparatus, and then executing the program code. In this case, the program code loaded from the storage medium implements the functions of the above-described embodiments, and therefore the program code itself and the storage medium in which the program code is stored also fall within the scope of the present invention.

The present invention further encompasses the case where an operating system (OS) running in a computer performs part or all of the actual processing based on the instructions of the program code, and the functions of the above-described embodiments are realized by that processing. The present invention further encompasses the case where the program code loaded from the storage medium is written into a memory provided in a function expansion card inserted into the computer, or a function expansion unit connected to the computer. In this case, a CPU provided in the function expansion card or the function expansion unit, or the like, performs part or all of the actual processing based on the instructions of the written program code, and the functions of the above-described embodiments are realized by that processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent No. 2007-187602, filed Jul. 18, 2007, which is hereby incorporated by reference herein in its entirety.

1. A device management apparatus that manages task processing devices that process document data by executing a job flow in which a plurality of tasks are combined in units of task, the apparatus comprising:
a deciding unit adapted to decide a primary task processing device from among the task processing devices under management;
a determining unit adapted to determine a task that requires obtainment of a license when executed by the primary task processing device from a job flow to be executed;
a license manager adapted to transfer a license of the task that is determined to require obtainment of a license when executing the task by the determining unit from another task processing device having the license to the primary task processing device; and
a scheduler adapted to schedule a task executable by the primary task processing device among the tasks included in the job flow such that the task is executed by the primary task processing device.

2. The device management apparatus according to claim 1, wherein the deciding unit determines a task processing device that can execute the largest number of tasks included in the job flow to be executed as the primary task processing device from among the task processing devices under management.

3. The device management apparatus according to claim 1, wherein the deciding unit determines a task processing device to which an instruction to execute a job flow to be processed is provided as the primary task processing device from among the task processing devices under management.

4. The device management apparatus according to claim 1, wherein the deciding unit determines a task processing device that can execute the largest number of tasks that require a user's manual operation included in the job flow to be executed as the primary task processing device from among the task processing devices under management.

5. The device management apparatus according to claim 1, further comprising a unit adapted to return a license having been returned from the primary task processing device to the another task processing device from which the license was obtained.

6. The device management apparatus according to claim 1, wherein, in response to a request from the primary task processing device, the license manager obtains a license from the another task processing device and assigns the license to the primary task processing device.

7. The device management apparatus according to claim 1, wherein, in response to a request from the primary task processing device, the license manager informs the primary task processing device of another task processing device that has the task license requested by the primary task processing device, and
the primary task processing device obtains the license from the informed another task processing device.

8. A job flow processing method in a device management apparatus that manages task processing devices that process document data by executing a job flow in which a plurality of tasks are combined in units of task, the method comprising:
a deciding step of deciding a primary task processing device from among the task processing devices under management;
a determining step of determining a task that requires obtainment of a license when executed by the primary task processing device from a job flow to be executed;
a license managing step of transferring a license of the task that is determined to require obtainment of a license when executing the task in the determining step from another task processing device having the license to the primary task processing device; and
a scheduling step of scheduling a task executable by the primary task processing device among the tasks included in the job flow such that the task is executed by the primary task processing device.

9. A computer-readable medium storing, in executable form, a program for executing causing a computer to execute a job flow processing method for managing task processing devices that process document data by executing the job flow in which a plurality of tasks are combined in units of task with a computer, the program being stored in a computer-readable storage medium, the job flow processing method comprising:
a deciding step of deciding a primary task processing device from among the task processing devices under management;
a determining step of determining a task that requires obtainment of a license when executed by the primary task processing device from a job flow to be executed;
a license managing step of transferring a license of the task that is determined to require obtainment of a license when executing the task in the determining step from another task processing device having the license to the primary task processing device; and
a scheduling step of scheduling a task executable by the primary task processing device among the tasks included in the job flow such that the task is executed by the primary task processing device.

10. A job flow processing system comprising:
the device management apparatus according to claim 1; and
at least one task processing device.

11. A task cooperative processing system that manages task processing devices that process document data by executing a job flow in which a plurality of tasks are combined in units of task, the system comprising:
a deciding unit adapted to decide a primary task processing device from among the task processing devices under management;
a determining unit adapted to determine a task that requires obtainment of a license when executed by the primary task processing device from a job flow to be executed;
a license manager adapted to transfer a license of the task that is determined to require obtainment of a license when executing the task by the determining unit from another task processing device having the license to the primary task processing device; and
a scheduler adapted to schedule a task executable by the primary task processing device among the tasks included in the job flow such that the task is executed by the primary task processing device.
